(19) United States
(12) Patent Application Publication
(10) Pub. No.: US 2015/0257024 A1
(43) Pub. Date: Sep. 10, 2015

(54) SELF-OPTIMIZATION OF BACKHAUL RADIO RESOURCES AND SMALL CELL BACKHAUL DELAY ESTIMATION

(71) Applicant: INTERDIGITAL PATENT HOLDINGS, INC., Wilmington, DE (US)

(72) Inventors: Akash Baid, Piscataway, NJ (US); Prabhakar R. Chitrapu, Blue Bell, PA (US); John L. Tomici, Southold, NY (US); John Cartmell, North Massapequa, NY (US)

(73) Assignee: InterDigital Patent Holdings, Inc., Wilmington, DE (US)

(21) Appl. No.: 14/428,936

(22) PCT Filed: Sep. 17, 2013
(86) PCT No.: PCT/US13/60063

§ 371 Date: Mar. 17, 2015

Related U.S. Application Data
(60) Provisional application No. 61/702,024, filed on Sep. 17, 2012.
(60) Provisional application No. 61/702,169, filed on Sep. 17, 2012.

(51) Int. Cl. H04W 24/08; H04W 76/04

(52) U.S. Cl. CPC H04W 24/08; H04W 76/041; H04W 84/045

(57) ABSTRACT

Control and/or management plane interactions may be implemented between one or more wireless backhaul links and respective associated access and/or core networks. The control and/or management plane interactions may be implemented in accordance with self-optimization functionalities and may be implemented to perform radio resource management (RRM) for the one or more wireless backhaul links. Packet-based synchronization and/or delay measurement techniques may be implemented to determine estimated values for wireless backhaul induced delay. The delay estimation information may be used by one or more devices in a wireless communications network, such as a packet data network gateway (PGW), a small cell gateway (SC GW), or an access point (AP), such as a small cell access point (SC AP). Delay estimation for wireless backhaul links may be implemented in accordance with PTP message replication and/or side-channel signaling, dual synchronization with GPS and PTP signaling, and/or timestamping.

### CROSS-REFERENCE TO RELATED APPLICATIONS

This application claims priority to U.S. provisional patent application Nos. 61/702,024, filed Sep. 17, 2012, and 61/702,169, filed Sep. 17, 2012, which are incorporated herein by reference in their entireties.

### BACKGROUND

Backhaul links that connect one or more base stations to a core network may be high capacity data pipes and may include little or no resource management functionality, for example if the backhaul links are fixed, wired, point-to-point links. If one or more wireless mediums are used to facilitate backhaul links, radio resources such as channel, power, and/or medium access parameters may be semi-statically configured, for example by third party backhaul service providers or operators of the wireless networks. Technology-specific dynamic re-configuration of radio resources may be employed, for instance based on link quality measurements and/or interference conditions.

However radio resource management (RRM) functionalities for wireless backhaul are typically implemented without direct interactions with access and/or core network components. Accordingly, wireless backhaul links are typically unable to leverage radio resource information that is typically available at an associated radio access network (RAN) and/or at an associated core network, such as traffic load, number and location of neighboring access points (APs), etc., while performing self-optimization processes.

In a typical wireless network deployment (e.g., a macro-cellular network), an associated backhaul system may include one or more high-capacity copper, fiber, and/or line of sight (LoS) microwave links. Such backhaul links may add substantially short, fixed, and measurable amounts of delay to packets transmitted over the backhaul links. Additionally, packets may be subject to little or no queuing delay, for example due to sufficient capacity on the backhaul links. Furthermore, propagation delay between a core network and a base station may remain substantially constant, for instance based on a length of a path between them.

However with increasing density of cellular network deployments (e.g., in small cells (SCs) and/or constraints on access point (AP) placement (e.g., on utility poles and/or lampposts), backhauling of wireless traffic may be implemented over wireless backhaul links which may have limited and/or variable capacity. Packets transmitted across wireless backhaul links may experience variable amounts of queuing and/or may accrue transmission delays before reaching an associated AP. It may be useful, for instance for the purpose of radio access scheduling and/or other resource management applications, to enable an AP (e.g., a small cell access point (SC AP)) to account for the variable delay that incoming packets may be subjected to, for instance during transmission over one or more respective wireless backhaul links.

### SUMMARY

Control and/or management plane interactions may be implemented between one or more wireless backhaul links and respective associated access and/or core networks. The control and/or management plane interactions may be implemented in accordance with self-optimization functionalities and may be implemented to perform radio resource management (RRM) for the one or more wireless backhaul links.

A process for self-optimization of a wireless backhaul link between a backhaul hub (BH) and a backhaul cell-site unit (BCU) that is connected to the BH over the wireless backhaul link may be performed. The process may include receiving a request to provision a specified bit rate over the backhaul link. The process may include determining whether the request can be fulfilled, for example based upon available radio resources. If the request can be fulfilled, the process may include reconfiguring the backhaul link in accordance with the specified bit rate.

Packet-based synchronization and/or delay measurement techniques may be implemented to determine estimated values for wireless backhaul induced delay. The delay estimation information may be used by one or more devices in a wireless communications network, such as a packet data network gateway (PGW), a small cell gateway (SC GW), or an access point (AP), such as a small cell access point (SC AP).

A process for estimating delay associated with an air interface between a small cell gateway (SCGW) and a small cell access point (SCAP) that is connected to the SCGW via the air interface may be performed. The process may include receiving queuing delay measurements over the air interface. The queuing delay measurements may be representative of respective delay measurements made on a plurality of packets queued at the SC GW. Each of the plurality of packets may have a respective QCI level associated therewith. The process may include generating delay estimation information associated with the air interface. The delay estimation information may be based upon the respective queuing delay measurements. The process may include providing the delay estimation information to a radio resource management (RRM) function.

An SC AP may be connected to an SC GW via an air interface. The SC AP may include a processor that is configured to receive queuing delay measurements over the air interface. The queuing delay measurements may be representative of respective delay measurements made on a plurality of packets queued at the SC GW. Each of the plurality of packets having a respective QCI level associated therewith. The processor may further be configured to generate delay estimation information associated with the air interface. The delay estimation information may be based upon the respective queuing delay measurements. The processor may further be configured to provide the delay estimation information to a radio an RRM function.

### BRIEF DESCRIPTION OF THE DRAWINGS

FIG. 1A depicts a system diagram of an example communications system in which one or more disclosed embodiments may be implemented.

FIG. 1B depicts a system diagram of an example wireless transmit/receive unit (WTRU) that may be used within the communications system illustrated in FIG. 1A.

FIG. 1C depicts a system diagram of an example radio access network and an example core network that may be used within the communications system illustrated in FIG. 1A.

FIG. 1D depicts a system diagram of an example radio access network and an example core network that may be used within the communications system illustrated in FIG. 1A.

FIG. 1E depicts a system diagram of an example radio access network and an example core network that may be used within the communications system illustrated in FIG. 1A.

FIG. 2 depicts example interactions between access, backhaul, and core portions of an example communications network.

FIG. 3 depicts an example of multi-hop wireless backhaul.

FIG. 4 depicts an example of an automatic neighbor relation function.

FIG. 5 depicts an example measurement made by an Access Point (AP) in a Network Listen Mode.

FIG. 6 depicts an example backhaul resource management architecture.

FIG. 7 depicts an example of reporting backhaul information over an X2 interface.

FIG. 8 depicts an example of user equipment (UE) assisted reporting of backhaul information.

FIG. 9 depicts an example of direct backhaul information measurement using a network listening mode (NLM).

FIG. 10 depicts an example of a backhaul neighbor relation table.

FIG. 11 depicts an example architecture for facilitating policy interactions between a policy and charging rules function (PCRF) and one or more wireless backhaul entities.

FIG. 12 depicts an example of backhaul neighbor discovery through backhaul-access interaction.

FIG. 13 depicts an example of AP-load driven backhaul bandwidth reconfiguration.

FIG. 14 depicts an example of policy-aware bandwidth reconfiguration.

FIG. 15 depicts an example of wireless communications in a macrocell, using a wired backhaul link that may exhibit fixed delay.

FIG. 16 depicts an example of delay-aware radio resource scheduling at a base station.

FIG. 17 depicts an example of wireless communication in a small cell, using a wireless backhaul link that may exhibit variable delay.

FIG. 18 depicts an example deployment of precision time protocol (PTP) in a macro cellular network.

FIG. 19 depicts an example PTP deployment in a small cell network.

FIG. 20 illustrates an example baseline delay measurement technique.

FIG. 21 depicts an example architecture using an established PTP infrastructure and associated messages.

FIG. 22 depicts an example of segregating PTP traffic into a dedicated fixed bandwidth channel.

FIG. 23 depicts an example PTP message replication architecture in which multiple PTP sessions may be initiated from a PTP slave device to an associated boundary clock.

FIG. 24 depicts an example architecture that may implement side-channel signaling based delay estimation.

FIG. 25 depicts an example of a multi-stage synchronization infrastructure deployment.

FIG. 26 depicts an example implementation of dual mode GPS/PTP synchronization in small cell (SC) clusters.

FIG. 27 depicts an example architecture configured for side-channel signaling without the use of PTP messages.

FIG. 28 depicts an example architecture configured for timestamping-based delay estimation.

FIG. 29 depicts an example architecture configured for use of PTP-based backhaul delay estimation for medium access control (MAC) scheduling.

FIG. 30 depicts example functionalities that may be implemented in a wireless communication network that includes a small cell gateway configured to account for delay therethrough.

### DETAILED DESCRIPTION

A detailed description will now be described with reference to the various figures. Although this description provides a detailed example of possible implementations, it should be noted that the details are intended to be exemplary and in no way limit the scope of the application. In addition, the figures may illustrate message sequence charts, which are meant to be exemplary. Other embodiments may be used. The order of the messages may be varied where appropriate. Messages may be omitted if not needed, and, additional messages may be added.

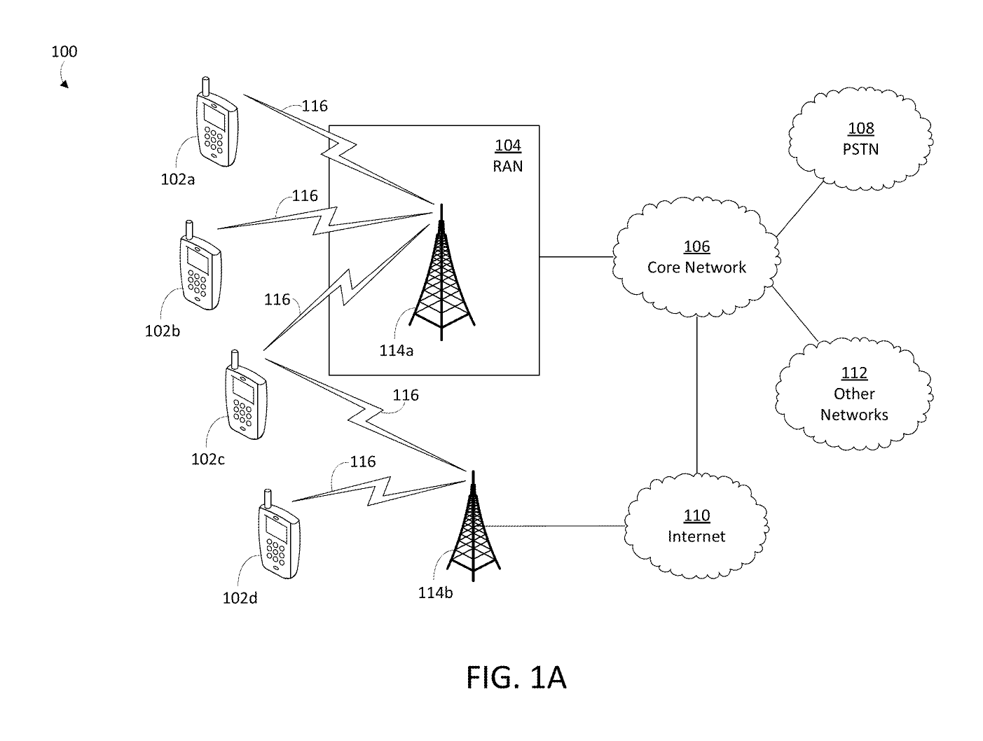

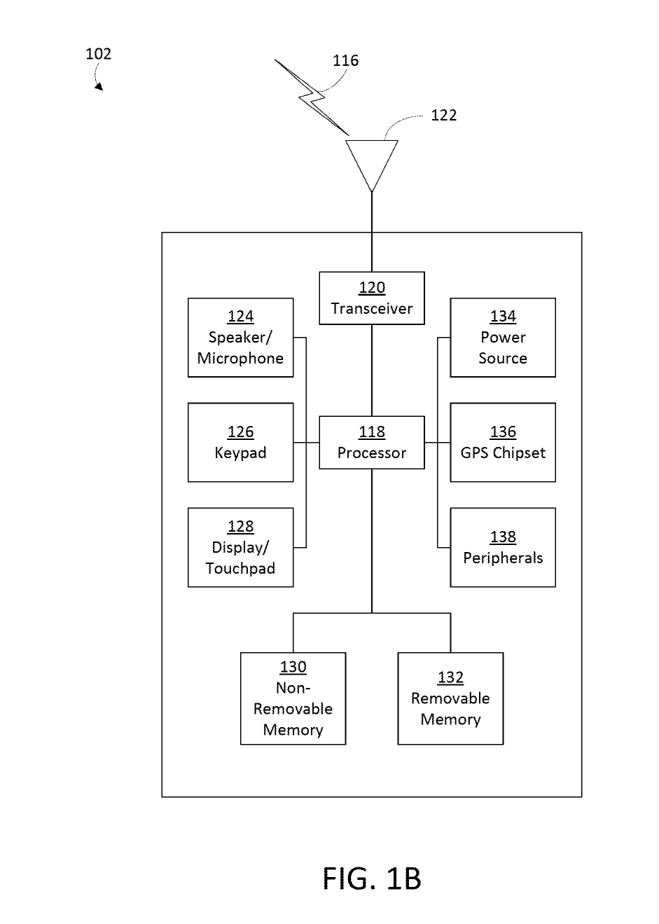

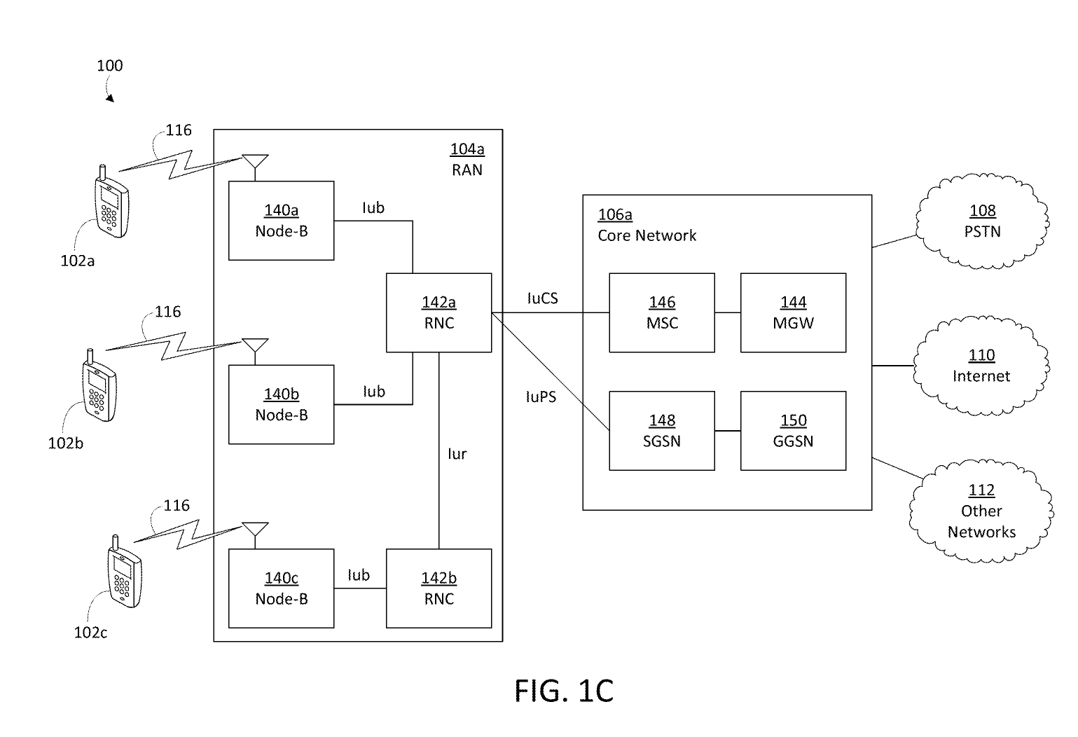

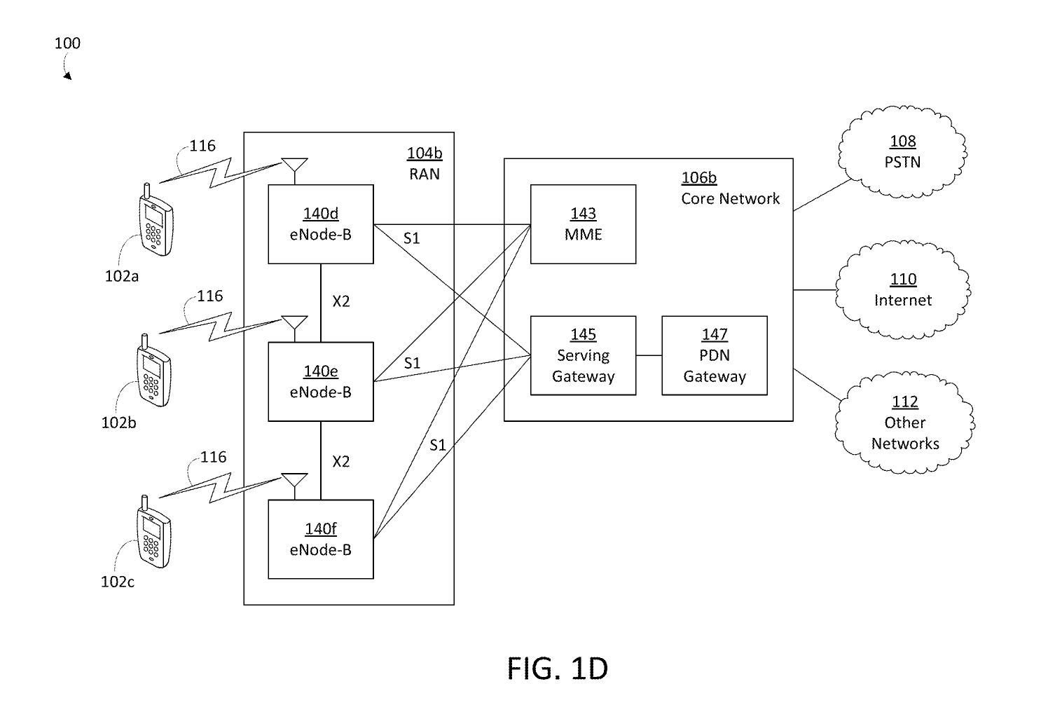

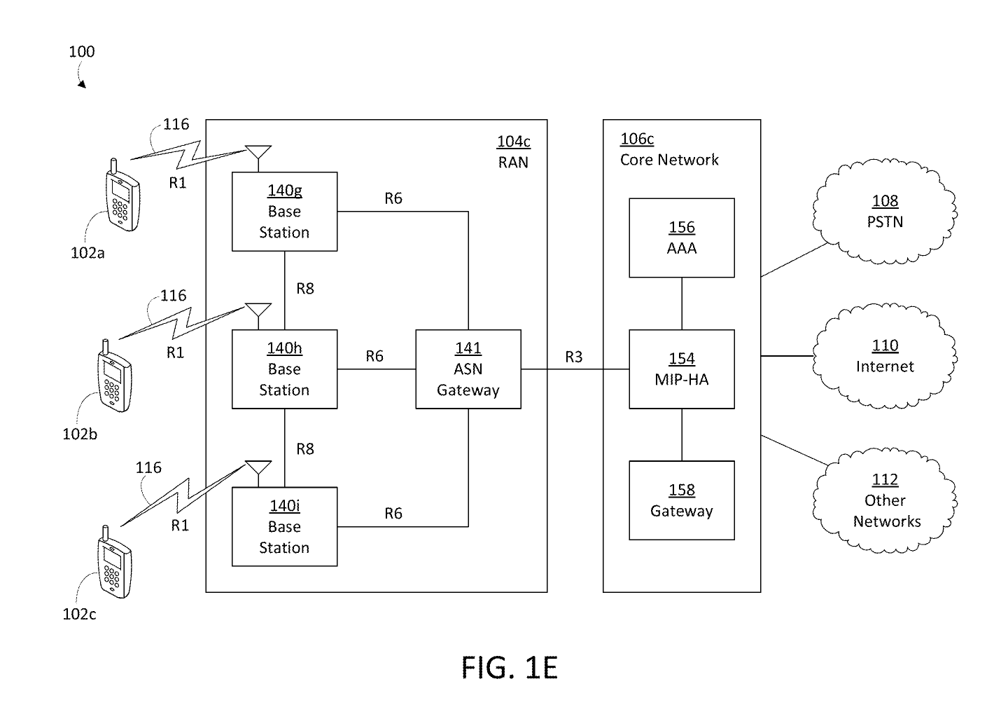

FIG. 1A is a diagram of an example communications system 100 in which one or more disclosed embodiments may be implemented. For example, a wireless network (e.g., a wireless network comprising one or more components of the communications system 100) may be configured such that bearers that extend beyond the wireless network (e.g., beyond a walled garden associated with the wireless network) may be assigned QoS characteristics.

The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include at least one wireless transmit/receive unit (WTRU), such as a plurality of WTRUs, for instance WTRUs 102a, 102b, 102c, and 102d, a radio access network (RAN) 104, a core network 106, a public switched telephone network (PSTN) 108, the Internet 110, and other networks 112, though it should be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it should be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it should be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It should be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it should be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It should be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It should be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of an embodiment of the communications system 100 that includes a RAN 104a and a core network 106a that comprise example implementations of the RAN 104 and the core network 106, respectively. As noted above, the RAN 104, for instance the RAN 104a, may employ a UTRA radio technology to communicate with the WTRUs 102a, 102b, and 102c over the air interface 116. The RAN 104a may also be in communication with the core network 106a. As shown in FIG. 1C, the RAN 104a may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104a. The RAN 104a may also include RNCs 142a, 142b. It should be appreciated that the RAN 104a may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106a shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements is depicted as part of the core network 106a, it should be appreciated that any one of these elements may be owned and/or operated by an entity other than the core network operator.

The RNC 142a in the RAN 104a may be connected to the MSC 146 in the core network 106a via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104a may also be connected to the SGSN 148 in the core network 106a via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106a may also be connected to the networks 112, which may include other wired or wireless networks that are owned and/or operated by other service providers.

FIG. 1D is a system diagram of an embodiment of the communications system 100 that includes a RAN 104b and a core network 106b that comprise example implementations of the RAN 104 and the core network 106, respectively. As noted above, the RAN 104, for instance the RAN 104b, may employ an E-UTRA radio technology to communicate with the WTRUs 102a, 102b, and 102c over the air interface 116. The RAN 104b may also be in communication with the core network 106b.

The RAN 104b may include eNode-Bs 140d, 140e, 140f, though it should be appreciated that the RAN 104b may include any number of eNode-Bs while remaining consistent with an embodiment. The eNode-Bs 140d, 140e, 140f may each include one or more transceivers for communicating with the WTRUs 102a, 102b, 102c over the air interface 116. In one embodiment, the eNode-Bs 140d, 140e, 140f may implement MIMO technology. Thus, the eNode-B 140d, for example, may use multiple antennas to transmit wireless signals to, and receive wireless signals from, the WTRU 102a.

Each of the eNode-Bs 140d, 140e, and 140f may be associated with a particular cell (not shown) and may be configured to handle radio resource management decisions, handover decisions, scheduling of users in the uplink and/or downlink, and the like. As shown in FIG. 1D, the eNode-Bs 140d, 140e, 140f may communicate with one another over an X2 interface.

The core network 106b shown in FIG. 1D may include a mobility management gateway (MME) 143, a serving gateway 145, and a packet data network (PDN) gateway 147. While each of the foregoing elements is depicted as part of the core network 106b, it should be appreciated that any one of these elements may be owned and/or operated by an entity other than the core network operator.

The MME 143 may be connected to each of the eNode-Bs 140d, 140e, and 140f in the RAN 104b via an S1 interface and may serve as a control node. For example, the MME 143 may be responsible for authenticating users of the WTRUs 102a, 102b, 102c, bearer activation/deactivation, selecting a particular serving gateway during an initial attach of the WTRUs 102a, 102b, 102c, and the like. The MME 143 may also provide a control plane function for switching between the RAN 104b and other RANs (not shown) that employ other radio technologies, such as GSM or WCDMA.

The serving gateway 145 may be connected to each of the eNode Bs 140d, 140e, 140f in the RAN 104b via the S1 interface. The serving gateway 145 may generally route and forward user data packets to/from the WTRUs 102a, 102b, 102c. The serving gateway 145 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 145 may also be connected to the PDN gateway 147, which may provide the WTRUs 102a, 102b, 102c with access to packet-switched networks, such as the Internet 110, to facilitate communications between the WTRUs 102a, 102b, 102c and IP-enabled devices.

The core network 106b may facilitate communications with other networks. For example, the core network 106b may provide the WTRUs 102a, 102b, 102c with access to circuit-switched networks, such as the PSTN 108, to facilitate communications between the WTRUs 102a, 102b, 102c and traditional land-line communications devices. For example, the core network 106b may include, or may communicate with, an IP gateway (e.g., an IP multimedia subsystem (IMS) server) that serves as an interface between the core network 106b and the PSTN 108. In addition, the core network 106b may provide the WTRUs 102a, 102b, 102c with access to the networks 112, which may include other wired or wireless networks that are owned and/or operated by other service providers.

FIG. 1E is a system diagram of an embodiment of the communications system 100 that includes a RAN 104c and a core network 106c that comprise example implementations of the RAN 104 and the core network 106, respectively. The RAN 104, for instance the RAN 104c, may be an access service network (ASN) that employs IEEE 802.16 radio technology to communicate with the WTRUs 102a, 102b, and 102c over the air interface 116. As described herein, the communication links between the different functional entities of the WTRUs 102a, 102b, 102c, the RAN 104c, and the core network 106c may be defined as reference points.

As shown in FIG. 1E, the RAN 104c may include base stations 102a, 102b, 102c, and an ASN gateway 141, though it should be appreciated that the RAN 104c may include any number of base stations and ASN gateways while remaining consistent with an embodiment. The base stations 102a, 102b, 102c may each be associated with a particular cell (not shown) in the RAN 104c and may each include one or more transceivers for communicating with the WTRUs 102a, 102b, 102c over the air interface 116. In one embodiment, the base stations 140g, 140h, 140i may implement MIMO technology. Thus, the base station 140g, for example, may use multiple antennas to transmit wireless signals to, and receive wireless signals from, the WTRU 102a. The base stations 140g, 140h, 140i may also provide mobility management functions, such as handoff triggering, tunnel establishment, radio resource management, traffic classification, quality of service (QoS) policy enforcement, and the like. The ASN Gateway 141 may serve as a traffic aggregation point and may be responsible for paging, caching of subscriber profiles, routing to the core network 106c, and the like.

The air interface 116 between the WTRUs 102a, 102b, 102c and the RAN 104c may be defined as an R1 reference point that implements the IEEE 802.16 specification. In addition, each of the WTRUs 102a, 102b, and 102c may establish a logical interface (not shown) with the core network 106c. The logical interface between the WTRUs 102a, 102b, 102c and the core network 106c may be defined as an R2 reference point, which may be used for authentication, authorization, IP host configuration management, and/or mobility management.

The communication link between each of the base stations 140g, 140h, 140i may be defined as an R8 reference point that includes protocols for facilitating WTRU handovers and the transfer of data between base stations. The communication link between the base stations 140g, 140h, 140i and the ASN gateway 141 may be defined as an R6 reference point. The R6 reference point may include protocols for facilitating mobility management based on mobility events associated with each of the WTRUs 102a, 102b, 102c.

As shown in FIG. 1E, the RAN 104c may be connected to the core network 106c. The communication link between the RAN 104c and the core network 106c may defined as an R3 reference point that includes protocols for facilitating data transfer and mobility management capabilities, for example. The core network 106c may include a mobile IP home agent (MIP-HA) 144, an authentication, authorization, accounting (AAA) server 156, and a gateway 158. While each of the foregoing elements is depicted as part of the core network 106c, it should be appreciated that any one of these elements may be owned and/or operated by an entity other than the core network operator.

The MIP-HA may be responsible for IP address management, and may enable the WTRUs 102a, 102b, and 102c to roam between different ASNs and/or different core networks. The MIP-HA 154 may provide the WTRUs 102a, 102b, 102c with access to packet-switched networks, such as the Internet 110, to facilitate communications between the WTRUs 102a, 102b, 102c and IP-enabled devices. The AAA server 156 may be responsible for user authentication and for supporting user services. The gateway 158 may facilitate interworking with other networks. For example, the gateway 158 may provide the WTRUs 102a, 102b, 102c with access to circuit-switched networks, such as the PSTN 108, to facilitate communications between the WTRUs 102a, 102b, 102c and traditional landline communications devices. In addition, the gateway 158 may provide the WTRUs 102a, 102b, 102c with access to the networks 112, which may include other wired or wireless networks that are owned and/or operated by other service providers.

Although not shown in FIG. 1E, it should be appreciated that the RAN 104c may be connected to other ASNs and the core network 106c may be connected to other core networks. The communication link between the RAN 104c the other ASNs may be defined as an R4 reference point, which may include protocols for coordinating the mobility of the WTRUs 102a, 102b, 102c between the RAN 104c and the other ASNs. The communication link between the core network 106c and the other core networks may be defined as an R5 reference point, which may include protocols for facilitating interworking between home core networks and visited core networks.

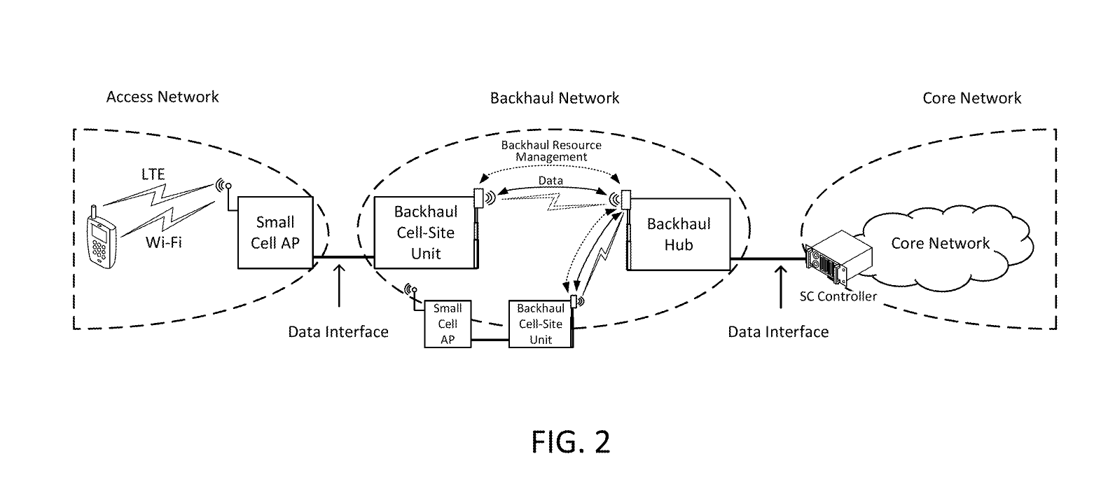

FIG. 2 depicts example interactions between access, backhaul, and core portions of an example communications network. Resource management pertaining to wireless backhaul links established in the backhaul portion of the illustrated network, which may be referred to as the backhaul network, may be performed in isolation with respect to access and/or core networks that may be associated with the backhaul network. A wireless backhaul network may include one or more backhaul cell-site units (BCUs) that may directly connect to respective access points (APs), for example small cell APs, and/or a backhaul hub (BH) that may connect the one or more BCUs to the core network. Radio resource management (RRM) functions pertaining to the one or more wireless backhaul links may include assignment of resources, management of interference, and the like.

Algorithms for performing RRM of one or more wireless backhaul links may be centralized at an associated BH and/or may be distributed, for example between one or more BCUs. Over-the-air transmissions associated with performing RRM of one or more wireless backhaul links may be synchronized or asynchronous. A multi-hop topology may be implemented, for example in a metro-scale public-access small cell deployment, in which an associated Backhaul Hub may be co-located with a macro eNB.

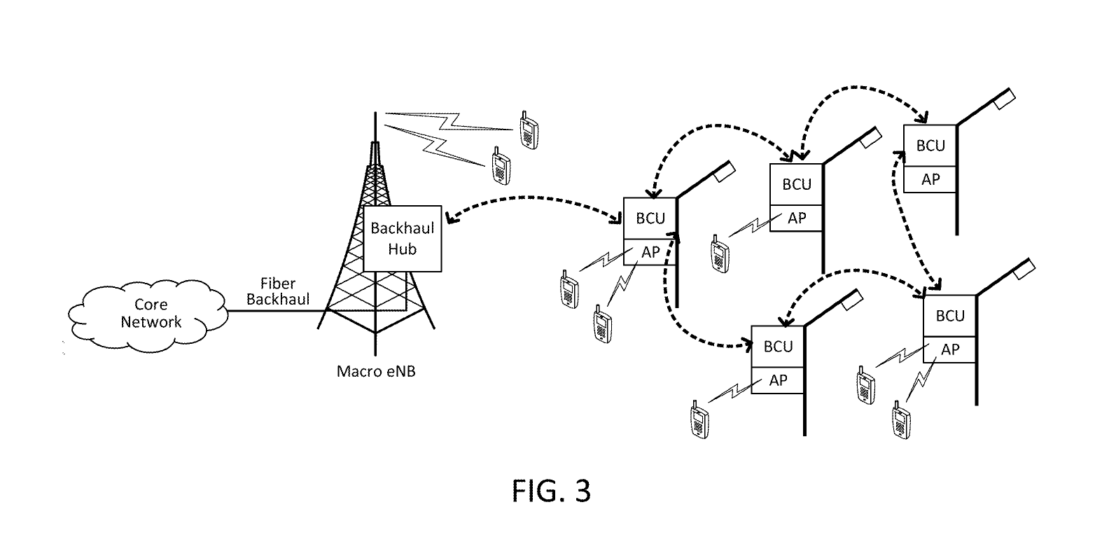

As depicted in FIG. 3, a wireless backhaul network may be configured such that one or more BCUs associated with the wireless backhaul network (e.g., each BCU associated with the wireless backhaul network) may relay traffic to and/or from an associated AP and/or may relay traffic to and/or from other BCUs in the backhaul network.

Wireless backhaul link resource management associated with the illustrated backhaul network may include spectrum allocation functionality. Depending, for example, on the implementing technology, wireless bandwidth used for backhaul may be channelized in a coarse grained manner (e.g., in Wi-Fi based systems) and/or in a fine-grained manner (e.g., for sub-carriers in OFDM based systems). A backhaul resource management system may assign spectrum resources to one or more different BCUs, for instance to minimize interference and/or maximize frequency re-use. Spectrum allocation may be performed dynamically, for example if associated traffic demand, interference patterns, and/or network topology changes with time.

Wireless backhaul link resource management associated with the illustrated backhaul network may include routing path functionality. For example, as depicted in FIG. 3, a plurality of paths may be defined between a BCU and an associated backhaul hub. Routing algorithms may be implemented, for instance to optimize a multi-hop path based between a BCU and an associated backhaul hub, and may be based on one or more metrics such as hop-count, total delay, etc. The routing algorithm may incorporate an amount of traffic generated and/or consumed by each node along the path, for example in order to prevent bottlenecks and/or additional queuing delays.

Wireless backhaul link resource management associated with the illustrated backhaul network may include monitoring and/or reconfiguration functionality. Channel access parameters may be configured for self-configuration and/or self-optimization, for example in order to account for changing radio conditions. Self-optimization may include, for example, changing and/or adapting one or more parameters (e.g., channel access parameters) in order to improve operation of a wireless communication system (e.g., a wireless backhaul network). Self-optimization may be performed autonomously (e.g., without user intervention). One or more BCUs, such as each BCU in the backhaul network, and/or the backhaul hub may be implemented with respective measurement functionalities. The backhaul hub may coordinate and/or distribute measurements performed by different nodes.

An automatic neighbor relation and/or discovery functionality may be implemented in a wireless backhaul network. One or more functions and/or procedures may be defined for enabling self-configuration and/or self-optimization. If one or more APs that participate in automatic neighbor discovery are linked (e.g., directly) with one or more respective backhaul units, substantially similar automatic neighbor discovery functionalities may be performed for wireless backhaul neighbor discovery.

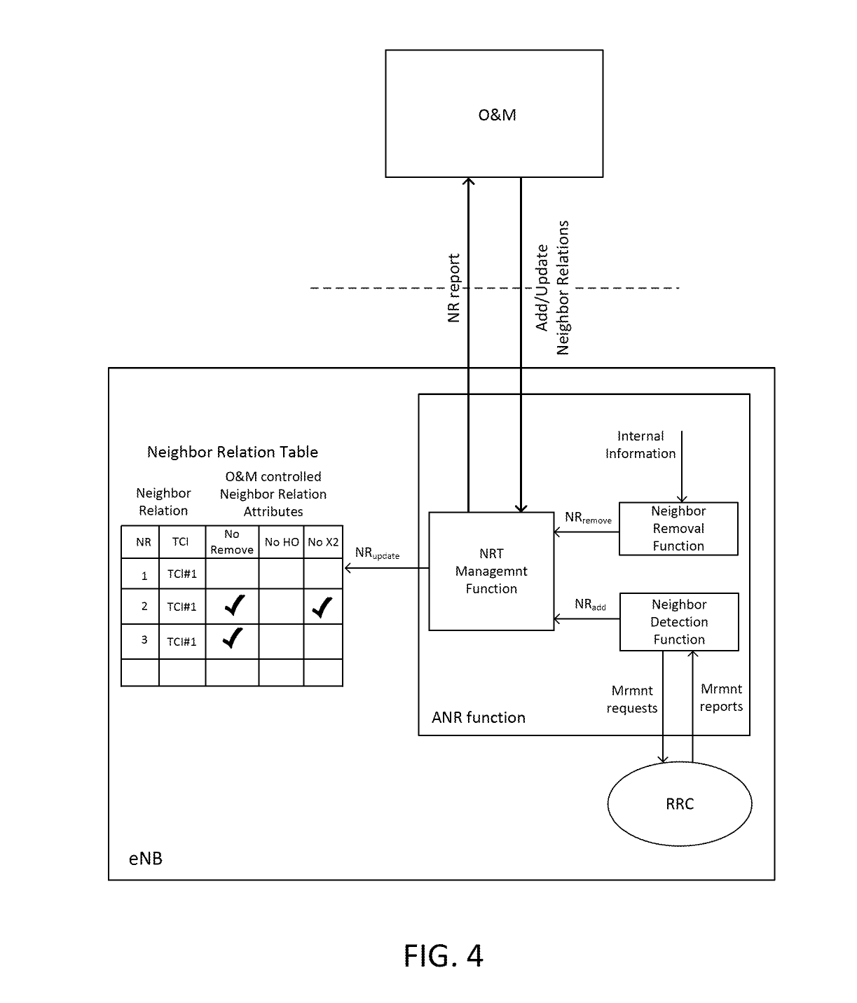

FIG. 4 depicts an example automatic neighbor relation (ANR) function that may relieve a wireless network operator from manually managing neighbor relations (NRs). By employing ANR, an associated eNB may maintain a cell-specific neighbor relation table (NRT) that may be populated by operations and management (O&M) functions that may reside in an associated core network and/or may be populated through RRC measurements, for example. The associated eNB may use one or more connected UEs to obtain respective measurements. A UE may report broadcasts from other eNBs to the associated eNB, for example broadcasts transmitted by eNBs within a select range, and/or may report their respective presences to the associated eNB. The associated eNB may setup one or more X2 interfaces directed to one or more discovered (e.g., neighboring) eNBs. Once setup, the X2 interface may be used for inter-cell interference coordination (ICIC), for example, in order to reduce or mitigate interference between neighboring cells, for mobility and/or handover related procedures, and/or the like. Time domain and/or frequency domain ICIC procedures may be implemented.

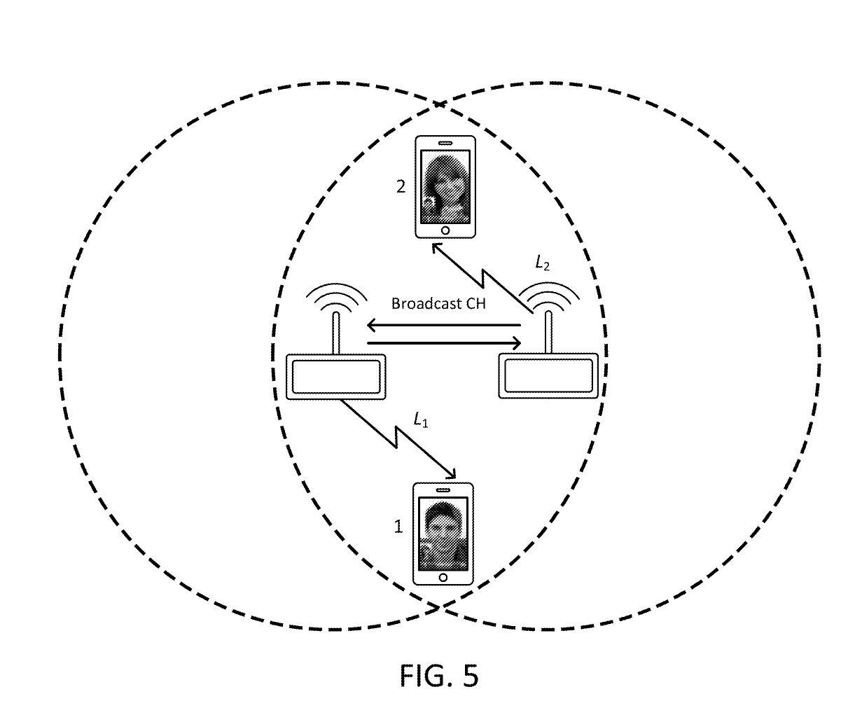

A network listen mode (NLM) functionality may be implemented in a wireless backhaul network. For example Home Node Bs (HNBs) and/or Home eNode Bs (HeNBs) associated with a wireless backhaul network may be implemented with NLM functionality such that the HNBs and/or HeNBs may be aware of one or more neighboring APs and/or macro base stations, and/or may be aware of corresponding power and/or spectrum allocations of the one or more neighboring APs and/or macro base stations. A HeNB implemented with a NLM functionality may perform radio level measurements if NLM is supported in an associated RAN implementation, as illustrated in FIG. 5.

Example measurements that may be used to identify one or more neighboring macro cell base stations may include PLMN ID, Cell ID, LAC, and/or RAC; a measurement source of one or more of which may be a HNB DL receiver. PLMN may be used to identify an operator and/or to distinguish between a macrocell and a HNB. Cell ID may be used to identify one or more surrounding macrocells. LAC may be used to distinguish between a macrocell and a HNB. RAC may be used to distinguish between a macrocell and a HNB.

Example measurements that may be used to identify one or more neighboring small cell APs may include co-channel CPICH RSCP and/or adjacent channel CPICH RSCP; a measurement source of one or both of which may be a HNB DL receiver. Co-channel CPICH RSCP may be used for calculation of co-channel DL interference toward one or more neighbor home user equipment devices (HUEs), for example from a HNB toward one or more HUEs, and/or may be used for calculation of co-channel UL interference toward one or more neighbor HNBs, for example from one or more HUEs toward one or more HNBs. Adjacent channel CPICH RSCP may be used for calculation of adjacent channel DL interference toward one or more neighbor HUEs, for example from a HNB toward one or more HUEs, and/or may be used for calculation of adjacent channel UL interference toward one or more neighbor HNBs, for example from one or more HUEs toward one or more HNBs.

An integrated backhaul resource management implementation may receive inputs (e.g., real-time inputs) from associated access and/or core networks and may adapt allocations based on changing traffic and/or interference patterns. One or more functionalities configured to provide assistance to backhaul resource management, for example from one or both of an access network and core network, may improve the efficiency of reconfigurations, resource allocation, and/or capacity of the backhaul network.

Access and/or core network assistance may be implemented for self-optimization of wireless backhaul systems. Information may be shared with a backhaul system by the access and/or core networks, for example to at least partially facilitate self-optimization of the backhaul system. Backhaul neighbor discovery may be implemented through access network assistance. Bandwidth re-configuration in the backhaul system may be implemented through access network assistance.

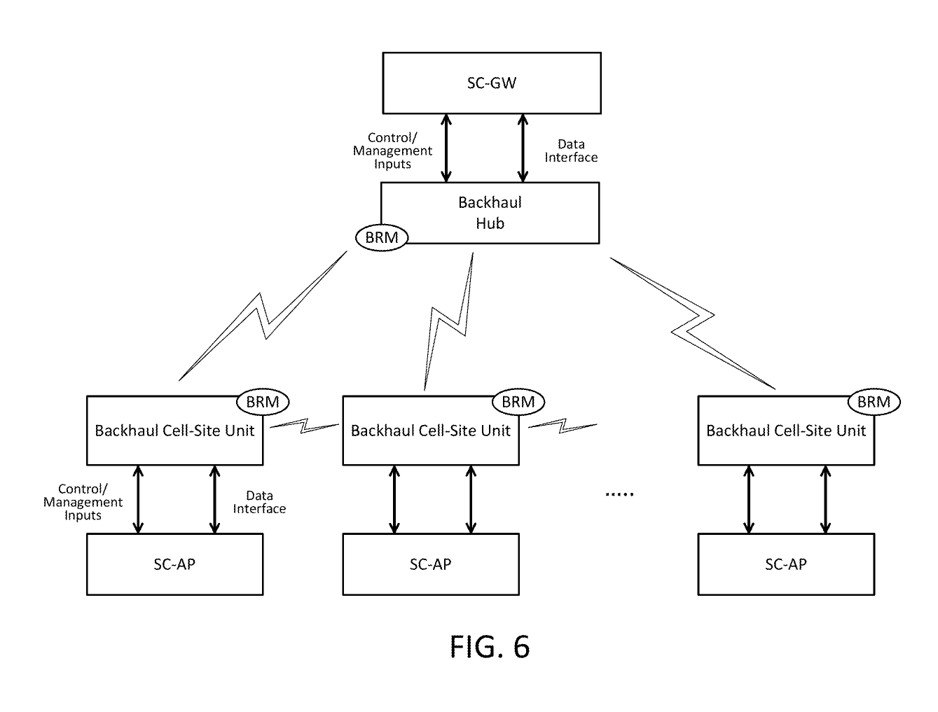

FIG. 6 depicts an example backhaul resource management architecture that may receive one or more inputs, such as an input provided to one or more BCUs from one or more connected access points (e.g., small cell access points (SC APs)) and/or an input provided to the BH from a small cell gateway (SC GW) and/or controller.

Inputs provided by a SC AP to an associated BCU may enhance an established data-only connection between the SC AP and the BCU and/or may enable RAN specific measurements to be exported to a backhaul resource management (BRM) functionality, for example in real-time. Inputs from an associated SC GW to the BH may enable aggregated traffic related information to be exported, for example from the core network to the backhaul domain. The aggregated traffic related information may be used for efficient resource management. Example information that may be provided to BRM functions by the RAN and/or core network entities may be as described herein. Enhancements may be implemented in an associated RAN and/or core network for measurement and/or aggregation of the information supplied to the backhaul network.

If one or more physical connections are established between the illustrated entities, mechanisms such as simple network management protocol (SNMP), if supported, may be used to transport messages associated with one or more of the inputs. Interfaces may be defined for dedicated control and/or management plane interaction between one or more backhaul network entities and associated access and/or core network entities.

Interactions between backhaul entities may be application dependent. One or both of distributed and centralized forms of backhaul resource management may be used along with the interactions described herein.

Information that may be provided by an SC AP may include information pertaining to one or more neighboring APs, information pertaining to one or more UEs (e.g., UEs connected to the SC AP and active, connected to the SC AP and idle, or previously connected to the SC AP), traffic related information, or the like.

An AP may ascertain backhaul related information from one or more neighboring APs. Backhaul related information may help the backhaul unit in discovery and/or reconfiguration. For example, AP to AP based communication using X2 may be implemented, broadcast messages may be implemented, or any combination thereof.

Backhaul related information that may be shared between APs may include transmission parameters, performance metrics, and/or path to BH information. Transmission parameters may include Tx power, frequency, channel, bandwidth, and/or the like. Performance metrics may include measured interference level, retransmission rate, average delay, and/or the like. Path to backhaul hub information may include a number of hops to the backhaul, capacity, latency of the path, and/or the like.

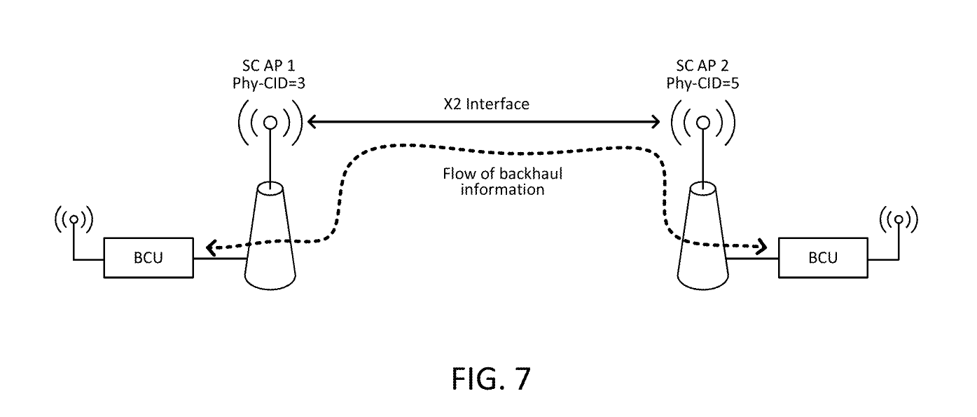

FIG. 7 depicts an example X2 based message exchange. Neighboring APs (e.g., SC AP 1 and SC AP 2) that may already have X2 based neighbor relations may leverage the X2 interface to transport backhaul related information. A connected BCU may inform an AP about respective BCU transmission parameters and/or performance metrics, for example as described herein. The AP may include the BCU transmission parameters and/or performance metrics information in one or more X2 messages directed to its neighbors, for example appended as an additional field. Passing of backhaul related information over X2 may be one or both of on-demand and periodic, and may be pull-based and/or push-based, in any combination as desired. For example, in accordance with a pull-based scheme, a requesting AP may query one or more of its neighboring APs, with which it may have an established X2 relationship, to transmit backhaul related information. In accordance with a push-based scheme, each AP may transmit backhaul related messages without waiting for a request.

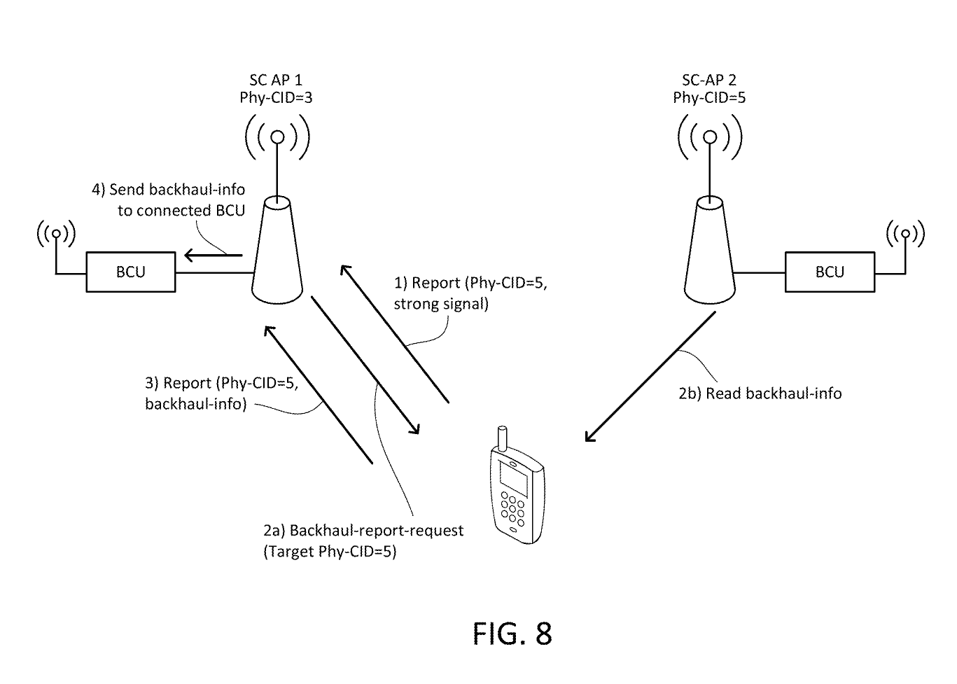

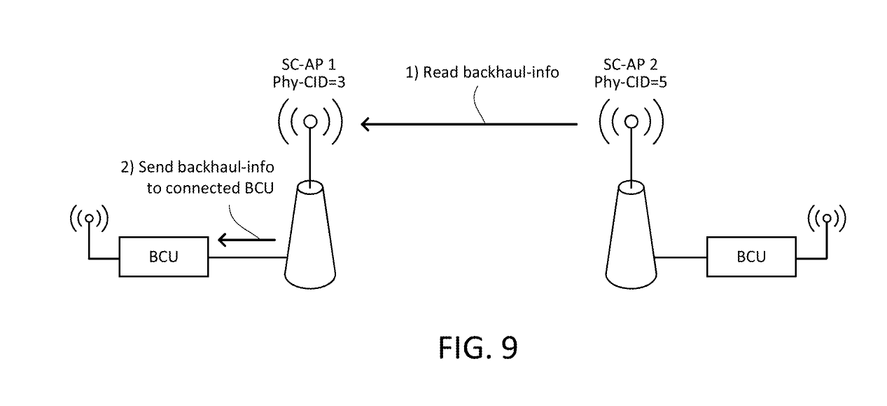

FIGS. 8 and 9 depict example broadcast based message exchanges that may rely on backhaul information being embedded in one or more periodic broadcast messages that may be sent by one or more AP, such as each AP. Network listen mode (NLM) and/or automatic neighbor relation (ANR) functionality may be implemented for one or more of the broadcast based message exchanges illustrated in FIGS. 8 and 9. If AP broadcasts are configured to include backhaul related information, UE assisted ANR and/or direct measurement by APs in NLM may be implemented.

FIG. 8 depicts an example of UE assisted ANR reporting of backhaul information. A measurement profile and/or triggers that may be exported from an AP to a UE may be modified to include the backhaul related information, such that one or more connected UEs may report back respective backhaul related information received from one or more neighboring APs. An AP may use one or more policies, for example to instruct one or more connected UEs to perform measurements and/or when to report the measurements to the AP.

If backhaul related information is included in one or more access network broadcasts, a procedure used to ascertain backhaul related information of neighboring APs through connected UEs may include a UE transmitting a measurement report pertaining to a second AP (e.g., SC AP 2) to a first AP (e.g., SC AP 1). In order to conserve resources (e.g., resources for measurement and/or reporting) an initial report may be limited to including a physical-cell identifier (Phy-CID) of the second AP and/or a signal strength of an access link between the UE and the second AP.

Depending, for example, on the signal strength and/or when the Phy-CID is detected, the first AP may instruct (e.g., request) the UE to read the backhaul info. To read the backhaul info, the second AP may schedule one or more appropriate idle periods, for instance to allow the UE to read the backhaul info from the broadcast channel of the second AP. When the UE obtains the backhaul information from the second AP, it may report the information to the first AP. The first AP may decide to transmit the backhaul information to a connected BCU, for example if the report meets one or more pre-set criteria, such as particular values for the channel, thresholds for power, interference measurements, or the like.

FIG. 9 depicts an example of direct backhaul information measurement by an AP, using an NLM. Backhaul related information may be gathered from neighboring APs, for example using AP based measurements through NLM functionality. One or more parameters pertaining to backhaul related information that an AP may gather while in listening mode may be defined. An example reporting process for providing the backhaul information to an associated BCU is illustrated in FIG. 9. For example, a first AP (e.g., SC AP 1) may read respective backhaul information pertaining to a second, neighboring AP (e.g., SC AP 2). The second AP may schedule one or more appropriate idle periods, for instance to allow the first AP to read the backhaul information from the broadcast channel of the second AP. When the first AP obtains the backhaul information from the second AP, it may provide the backhaul information to a connected BCU, for example if the backhaul information meets one or more pre-set criteria, such as particular values for the channel, thresholds for power, interference measurements, or the like.

If one or more UEs associated with a wireless backhaul network and/or an associated RAN do not use the same radio access technology as the wireless backhaul network, direct measurement of the path loss between a neighboring AP and a given AP and/or UE pertaining to backhaul transmissions may not be made through the above-described mechanisms. Reports provided to a wireless backhaul network, for example that include backhaul information pertaining to neighboring APs in the wireless backhaul network, may help one or more backhaul units (e.g., BCUs) to tune and/or perform power-measurements at respective reported channel and/or frequency bands, and may relieve the one or more backhaul units from scanning one or more potentially wide sets of frequencies that neighboring APs may use for backhaul.

If the range of a wireless backhaul link differs from the range of an associated RAN, a set of neighbors detected through RAN measurements may differ from a set of possible interferers detected by the backhaul network. In select wireless backhaul network deployments, such as dense metro deployments, respective sets of access-neighbors and backhaul-neighbors may substantially overlap each other. One or more backhaul units (e.g., BCUs) may be configured to perform additional measurements if there are differences (e.g., substantial differences or differences above a threshold) between the respective sets of access-neighbors and backhaul-neighbors.

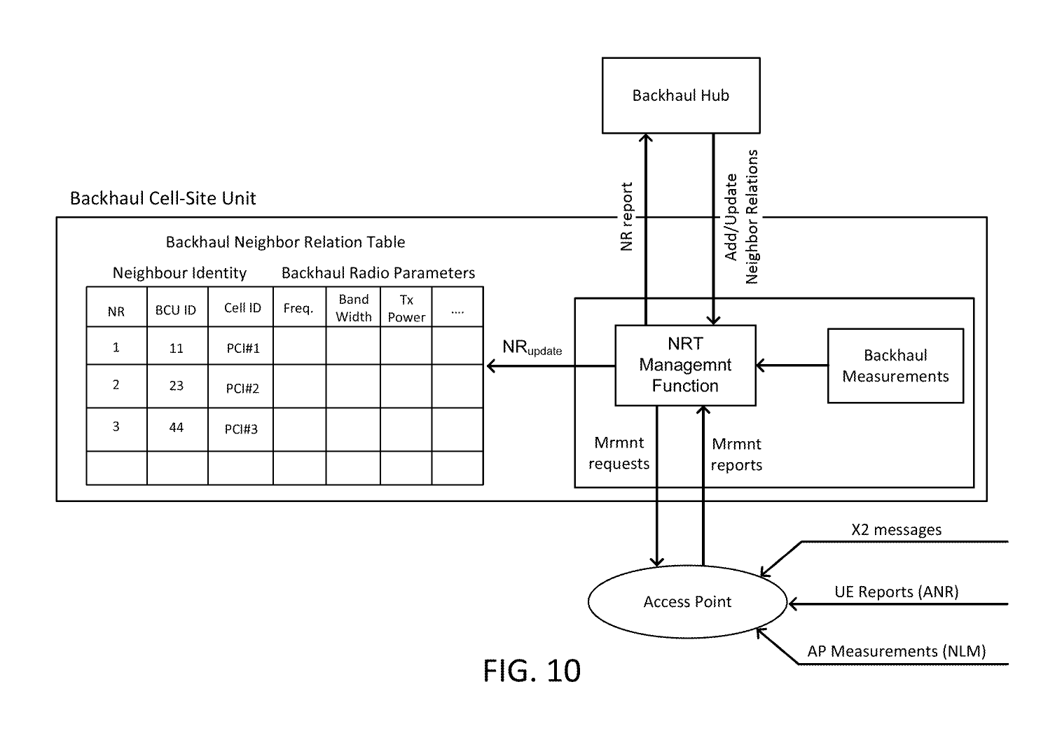

A backhaul unit (e.g., a BCU) may maintain a backhaul neighbor relation table. The backhaul neighbor relation table may include information received from one or more associated APs, for example. A backhaul neighbor relation table may be structured similarly to a neighbor relation table maintained for RAN associated neighbors, and may be at least partially populated using measurements made on the wireless backhaul network, for example directly. An example backhaul neighbor relation table is depicted in FIG. 10.

A bandwidth capacity of a wireless backhaul link associated with an AP may be at least partially determined in accordance with a number of UEs actively connected to the AP. Information pertaining to UEs actively connected to the AP, for example the number, type, and signal strength of the connected UEs, may be used to adapt backhaul capacity dynamically. RAN capacity and backhaul capacity may be dependent upon each other. For example, when a large number of UEs are connected to an AP, a RAN capacity may be substantially high and a corresponding backhaul capacity may be substantially low, for example due to statistical averaging of varying signal quality and/or corresponding link spectral efficiency. When a small number of UEs are connected to the AP (e.g., a single UE that is located close to the AP), a RAN capacity may be substantially low and a corresponding backhaul capacity may be substantially high.

An AP (e.g., a SC AP) may supply information to a connected BCU (e.g., periodically), responsive to pre-defined triggers such as more than a threshold change from last reported values, or the like, in any combination. Information reported to a BCU by an associated AP may include one or more of: a number of actively connected UEs; a metric capturing the average spectral efficiency of assigned RAN resources that may be conveyed, for example, through a number of bits transmitted per resource block in an uplink and/or downlink; one or more median and cell-edge UE scheduling delays; or any combination of the above or any other suitable parameters. If buffer sizes on the RAN scheduler are high, associated wireless backhaul links may not cause a bottleneck. In a multi-RAT AP, the above-described parameters may be specified separately for different RATs, for example if their respective inference may differ.

Gateway nodes may serve as tunnel end-points for various UE level and/or AP level protocols. Information may be collected from such gateway nodes and may be supplied to the backhaul network, and may be used by the backhaul network to optimize one or more resource allocations.

UE level information may be representative of an amount of bandwidth used to backhaul traffic, for example from an AP to an associated core network. One or more of the following UE related information may be supplied by associated gateway nodes to a backhaul hub: total number of UE tunnels that the backhaul hub is to support; average, instantaneous, and/or peak throughput per UE tunnel; or any other suitable tunnel properties, such as end-to-end latency. End-to-end latency may be used as feedback pertaining to backhaul performance. For example, if latency in the backhaul is above a pre-set threshold, additional resources may be assigned.

AP level information, such as aggregated statistics per AP, may be made available at one or more associated gateways. One or more of the following AP-level information may be reported from gateway nodes to the backhaul hub: aggregated average, instantaneous, and/or peak throughputs per AP; respective types of tunnels from gateway to AP, that may convey information about the type of RAT used (e.g., 3G, 4G, or Wi-Fi); number of UEs per AP; number of tunnels per AP; or any other suitable AP-level information.

An interface may be defined that may be used to export policy control instructions to one or more wireless backhaul entities. For example, an S9a interface defined for policy interactions between a policy and charging rules function (PCRF) and a broadband policy control function (BPCF) may be enhanced, for example to include wireless specific functions that may be used for policy-level interactions between a core network and a wireless backhaul network.

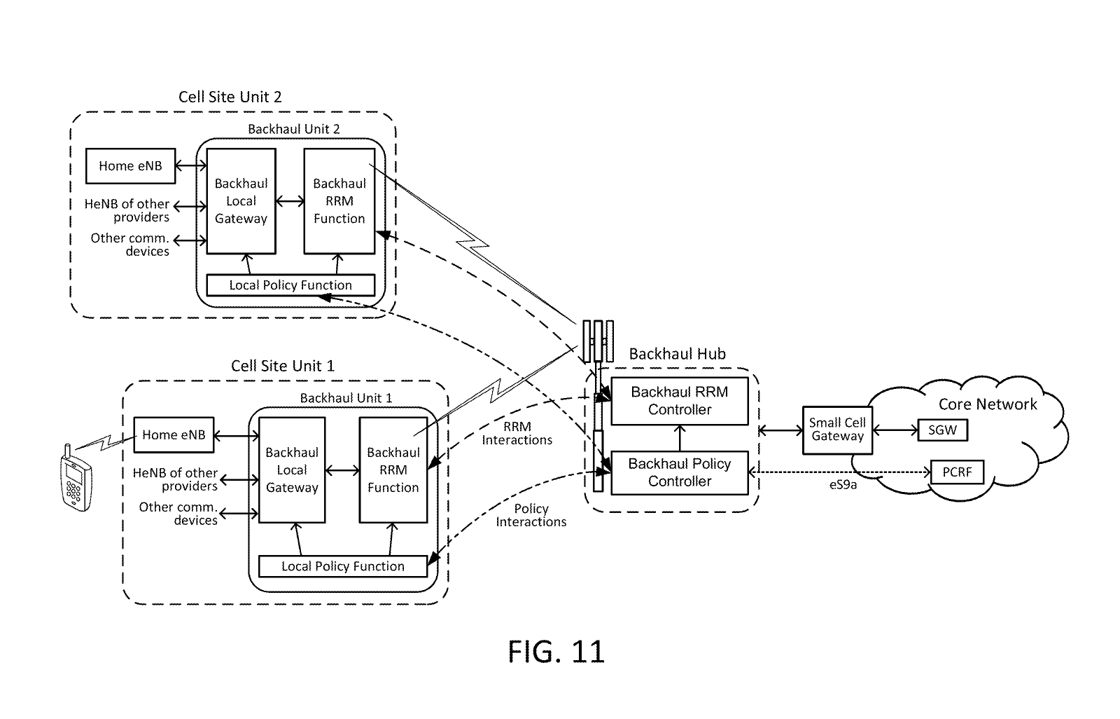

FIG. 11 depicts an example architecture for facilitating policy interactions between a core network and a wireless backhaul network. An interface, such as an enhanced form of an S9a interface (e.g., eS9a), may be defined between a PCRF and a Backhaul Hub of a wireless backhaul network. The Backhaul Hub may be configured to perform one or more logical functions, for instance to operate as a backhaul RRM controller (BRC) and/or as a backhaul policy controller (BPC). As illustrated in FIG. 11, policy inputs from the PCRF to the BPC may be used to drive resource management in the backhaul network, for example through direct interaction with the BRC residing in the hub, through local policy function agents residing in one or more associated BCUs, or any combination thereof.

One or more service level (e.g., per service data flow (SDF) and/or per SDF aggregate) quality of service (QoS) parameters may be exported by a PCRF, including QoS class identifier (QCI), allocation and retention priority (ARP), guaranteed bit rate (GBR), and/or maximum bit rate (MBR). QCI parameters may include characteristics that describe a packet forwarding treatment that an SDF aggregate may receive (e.g., edge-to-edge between a UE and a policy and charging enforcement function) in terms of one or more of the following performance characteristics: resource type (e.g., GBR or Non-GBR); priority; packet delay budget; packet error and/or loss rate.

An ARP QoS parameter may include information about a priority level, a pre-emption capability, pre-emption vulnerability, or the like. The priority level may define a relative importance of a resource request. A GBR resource type may determine if dedicated network resources related to a service and/or bearer level GBR value may be permanently allocated (e.g., by an admission control function in a radio base station). GBR SDF aggregates may be authorized on demand (e.g., using dynamic policy and/or charging control). An MBR parameter may limit a bit rate that may be provided by a GBR bearer, for instance such that excess traffic may be discarded, by a rate shaping function for example.

A backhaul policy controller (BPC) may reside in the Backhaul Hub of a wireless backhaul network, and may perform mapping of QoS information (e.g., QCI, bit rates, and/or ARP), for example QoS information received over an interface defined between a PCRF and the backhaul hub (e.g., eS9a).

A BPC may be configured to make policy-aware RRM decisions. In order to satisfy one or more bit-rate guarantees specified by a PCRF, a radio resource allocation policy may be modified, for instance such that one or more RRM functionalities may be made policy-aware.

For example, a bandwidth allocation RRM functionality may be made policy-aware. Based on respective bit-rates that may be indicated as required for one or more bearers exported by the PCRF, the BPC may determine respective identities of one or more BCUs (e.g., each BCU) that the one or more bearers traverse, for instance in a multi-hop setting. The BPC may inform the BRC, so as to ensure allocation of respective appropriate bandwidth capacities to the identified BCUs. If additional resources are to be allocated to a select cell-site (e.g., responsive to an indicated need), the BRC may re-compute one or more bandwidth allocations in order to determine a bandwidth allocation policy that may substantially satisfy one or more requirements that may be provided by the BPC.

A multi-hop route calculation RRM functionality may be made policy-aware. Route calculations may be performed by the BPC, so as to ensure availability of appropriate bandwidth along one or more paths in a multi-hop backhaul setting. Established routes may be modified, for example by the BRC, so as to accommodate bit-rates that may be indicated as required minimums.

A BPC may be configured to distribute policy inputs to one or more local policy functions. For example, when a BPC receives QoS information for a select bearer, it may distribute access control and/or QoS rules to one or more BCUs (e.g., each BCU) that are involved in carrying the select bearer. One or more policies, such as policing a maximum bandwidth generated by a UE and/or an AP, may be exported to at least a first backhaul cell to which the AP is connected to (e.g., to only the first backhaul cell to which the AP is connected). In select scenarios, for example when ensuring minimum bit-rates, each entity associated with the BPC may be informed about the policy. The BPC may keep track of changes in the route and/or may inform one or more nodes en-route about, for example, flow specific bit-rates that may be indicated as required.

One or more wireless backhaul RRM functions may be enabled using RAN and/or core network inputs. In accordance with wireless backhaul self-optimization, one or more backhaul nodes may discover neighboring nodes, for example a neighboring node that may have a better path to an associated backhaul hub (e.g., a path having lower latency, higher bandwidth, or the like).

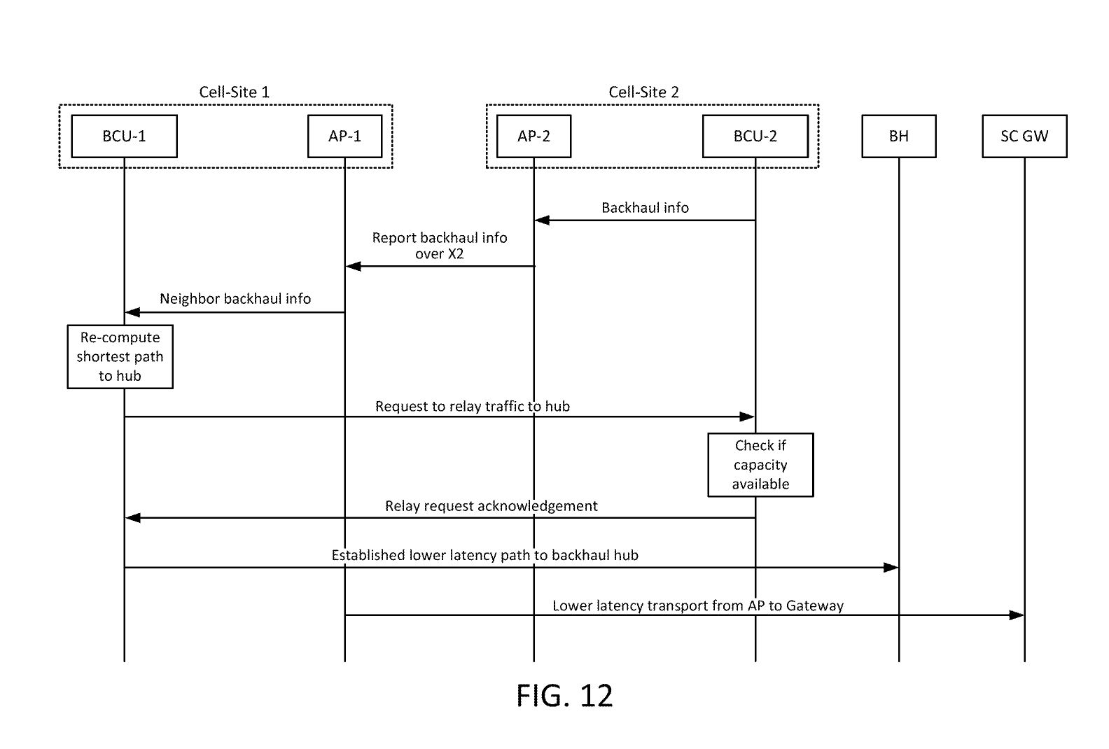

FIG. 12 depicts an example of backhaul neighbor discovery through backhaul-access interaction. As illustrated, a first cell site (e.g., Cell-site 1) may have a pre-established path to an associated backhaul hub. A second cell site (e.g., Cell-site 2) may come up in the system. The second cell site may offer a second path to the backhaul hub from the first cell site that is more desirable than an established first path to the backhaul used by the first cell site. Before the first cell site may use the second path, a first BCU (e.g., BCU-1) to which the first cell site is connected may first discover a presence of a second BCU (e.g., BCU-2) to which the second cell site is connected. Discovery of the second BCU may be performed through periodic scanning, for example by the first BCU, through a supported spectrum in order to listen for beacon transmissions from the second BCU. Such periodic scanning and/or listening may be implemented via dedicated listening time, which may reduce backhaul throughput. A set of potential frequency options and/or channels to be scanned and/or listened to, and on which the second BCU may transmit, may be sufficiently large in number so as to consume an undesirably long listening period.

Backhaul information pertaining to the second BCU, for example including path information from the second BCU to the backhaul hub, may be conveyed to the first BCU, for example using access point to access point (AP-AP) communication through one or more inputs described herein, and/or through one or more other suitable inputs, as desired.

FIG. 12 illustrates an X2-based messaging approach, but any other suitable messaging scheme may be implemented (e.g., as illustrated in FIGS. 8 and/or 9), in any combination. When the first BCU has knowledge of one or more transmission characteristics and/or path information pertaining to the second BCU, the first BCU may directly communicate with the second BCU, for instance in order to establish a more desirable transmission path between the first BCU and an associated backhaul hub (e.g., a path having lower-latency). The illustrated backhaul neighbor discovery through backhaul-access interactions may result in the establishment of a more desirable (e.g., lower-latency) transport path from a first access point (e.g., AP-1) in the first cell site to a corresponding gateway.

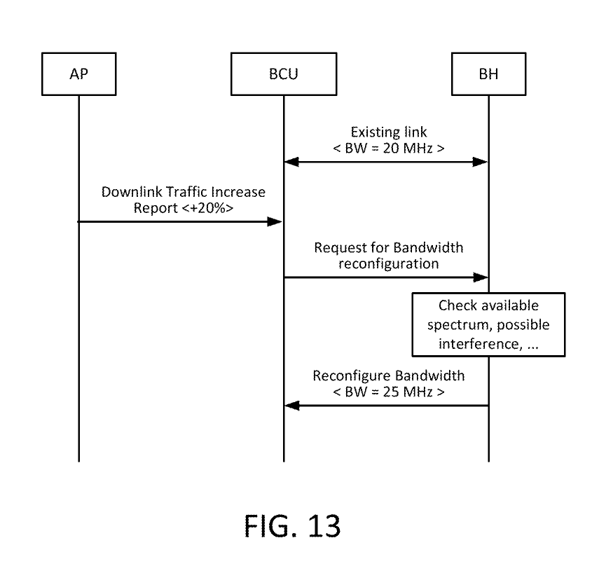

FIG. 13 depicts an example of AP-load driven backhaul bandwidth reconfiguration. Access-side information may be used for backhaul resource management, such as dynamic reconfiguration of the backhaul bandwidth assignment, for example based on a load on the AP side. In the example illustrated in FIG. 13, an established link between a BCU and a backhaul hub (BH) may be configured to operate with a select bandwidth (e.g., 20 MHz). At some point in time, load conditions at the AP may change, for example an amount of downlink data served by the AP may increase (e.g., by 20%). If the backhaul link is operating near its capacity limit, the changing load conditions may increase delays on the backhaul link, which may lead to a lower quality of experience for one or more connected UEs.

Using one or more of the inputs described herein, or other suitable inputs, the AP may report information pertaining to the changing load conditions, for example to the associated BCU. The BCU may request extra bandwidth from the BH. One or more bandwidth assignments may be managed by the BH, and/or may be self-determined. If one or more bandwidth assignments are self-determined, co-ordination may be implemented between BCUs that may be operating in an overlapping region, so as to avoid interference. The BH, depending on whether unused spectrum is available and/or if the bandwidth of some other BCU may be decreased, may assign extra bandwidth for the BCU in consideration.

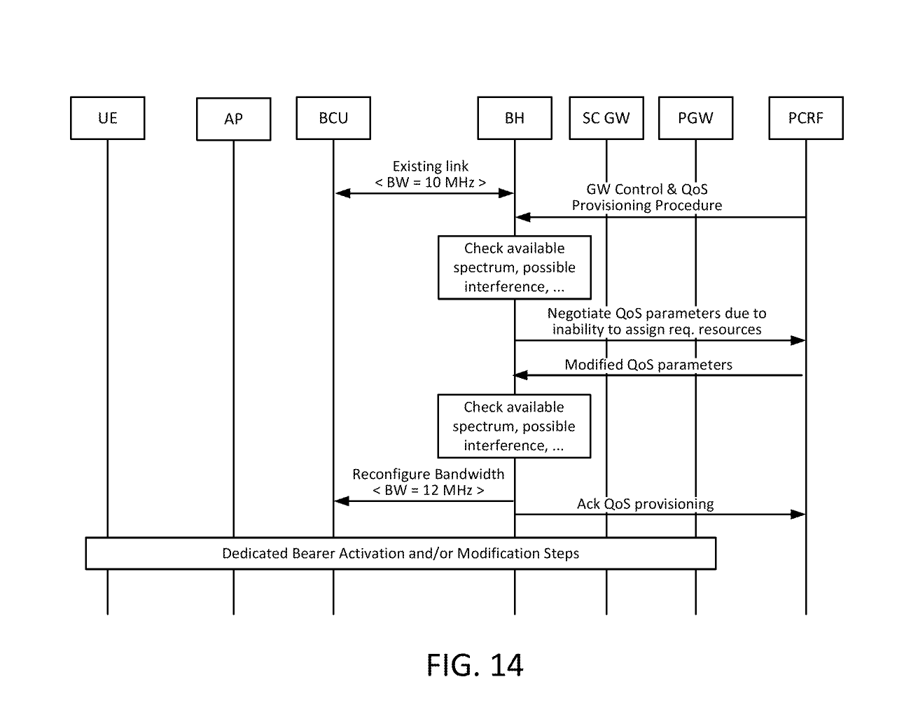

FIG. 14 depicts an example of policy-aware bandwidth reconfiguration. Policy-aware re-configuration of backhaul radio resources may be implemented in accordance with network-initiated bearer activation and/or modification. For example, interactions between a BPCF and a PCRF of a core network may be enhanced, for instance for network initiated bearer activation, modification, and/or deactivation.

An established link between a BCU and an associated BH may be assigned a select portion of bandwidth (e.g., 20 MHz) for backhaul operation. The PCRF may initiate a bearer activation and/or modification procedure, for example by requesting the BH to provision a specified bit-rate for the modified flow. The BH may determine that there is not enough capacity available to satisfy a GBR requested by the PCRF, and may make a counter-offer citing the available bandwidth. The PCRF may respond with a modified request, for example a modified request having a lower QoS provision (e.g., a lower QoS requirement). The BH may again check if extra resources may be allocated to the BCU in question, and may approve the QoS provisioning request if capacity is available. If backhaul bandwidth is increased, a dedicated bearer between the UE and the P-GW may be activated and/or modified, for example in accordance with TS 23.401.

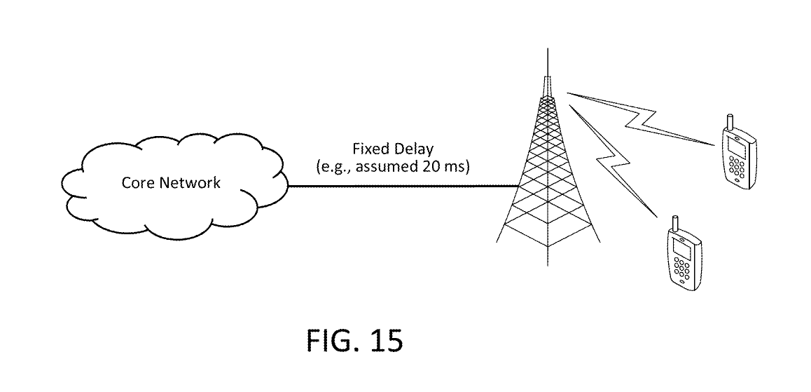

FIG. 15 depicts an example of a wired backhaul link that may be deployed, for example, in accordance with wireless communication in a macrocell (e.g., between a core network and a base station). A wired backhaul link may add a small, constant amount of delay to packets transmitted across the wired backhaul link. The delay may be assumed to be a fixed amount of delay, for instance for the purposes of macrocell operation. For example, a delay of approximately 20 ms for the delay between a policy and charging enforcement function (PCEF) and the base station may be subtracted from a given packet delay budget (PDB) to derive a PDB that may apply to a respective radio interface. The delay may be the average between a case where the PCEF may be located proximate to the radio base station (e.g., roughly 10 ms) and a case where the PCEF may be located further from the radio base station, for example in a case of roaming with home routed traffic. For instance, one-way packet delay between Europe and the US west coast may be roughly 50 ms. The above average may take into account that roaming is a less typical scenario. Subtracting the average delay of 20 ms from a given PDB may lead to a desired end-to-end performance.

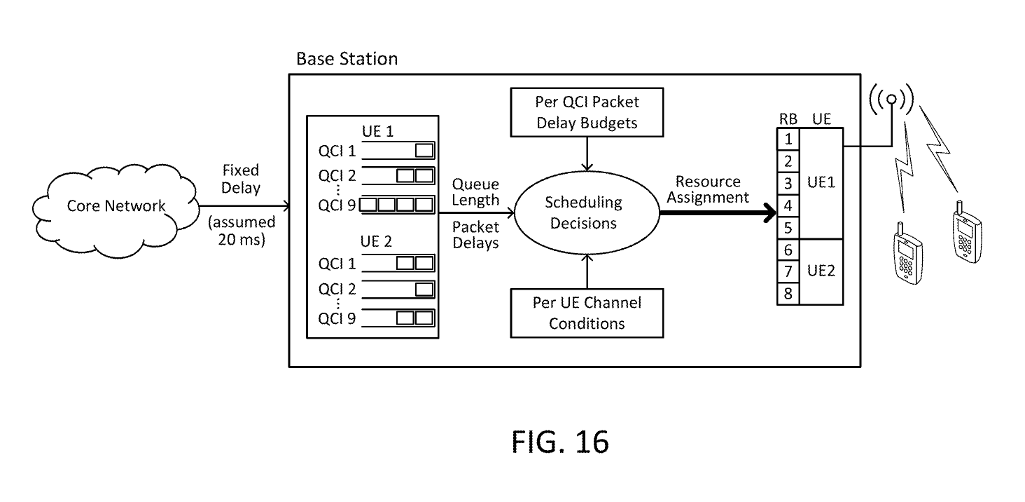

A functionality that may be impacted by a fixed backhaul delay assumption is QoS aware radio resource scheduling. Since packets arriving at a base station may have undergone the same delay, a radio resource scheduling algorithm at an associated base station may provide differential treatment to incoming packets, for example based on respective QoS class identifier (QCI) markings. A delay-aware scheduling algorithm may take into account a queuing delay at the base station. If delay induced in a backhaul system is assumed to be the same, one or more delay counters (e.g., all delay counters) may be started from zero. Resources may be assigned to UEs that have high delay times and/or high spectral efficiency values. For example, UEs that have one or both of high head-of-line delay or good channel conditions may be given priority. A scheduling policy may assign equal priority to packets of all QoS classes, for example until their delay approaches a packet delay budget for that class. When the packet delays approach a deadline, the scheduling priority of those packets may be increased. FIG. 16 depicts the operation of a delay-aware scheduler that may be used in a macro-cellular network, for example the example wireless communications network depicted in FIG. 15.

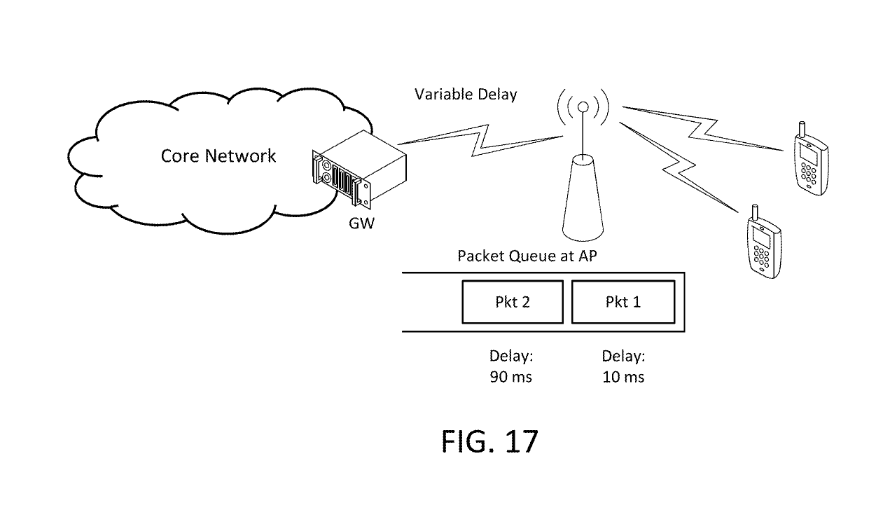

A fixed delay assumption may be mostly valid for one or more base stations of a macro-cellular network, but may be at least partially invalid for cellular networks having smaller cell deployments (e.g., small cells) or cellular networks lacking cell planning (e.g. small cells). FIG. 17 depicts an example of a wireless backhaul link that may be deployed, for example, in accordance with wireless communication in a small cell network (SCN), for example between a core network (e.g., a gateway (GW) device) and a small cell access point (AP).

A backhaul system in a small cell network (SCN) may introduce an increased and/or varying amount of delay to one or more packets that it transports, which may be attributed to a number of reasons, for example as described herein. For example, two packets marked with QCI 2 (corresponding to a packet delay budget of 150 ms) may arrive at an AP at substantially the same time. The two packets may have ensued delays of 10 ms and 90 ms, respectively, in the wireless backhaul link. If a scheduling algorithm at the AP does not take this variable delay into account, the scheduling algorithm may miss the delay target of the second packet.

Increased and/or varying delay in a SCN backhaul link may be attributed to one or more factors, including: queuing on a limited capacity link (e.g., wireless, wired, self-backhaul, etc.); use of adaptive coding and/or modulation schemes to address radio path fading; interference induced retransmission on a wireless link (e.g., NLoS microwave, Wi-Fi, etc.); multi-hop backhaul (e.g., LoS/NLoS microwave) that may introduce processing delay (e.g., on one or more hops, etc.); backhaul through the public Internet may introduce processing and/or queuing delays at one or more routers on the path; or delays due to sharing of the backhaul link between multiple operators.

Synchronization may be implemented in a cellular network. Delay estimates (e.g., delay in one or more backhaul links in a SCN) may be derived based upon the time synchronization infrastructure (e.g., the synchronization protocol) of a cellular network.

Accurate frequency synchronization may be indicated as a requirement in a cellular network. Phase synchronization may be indicated as a requirement for universal mobile telecommunications system (UMTS)-time-division duplexing (TDD) (UMTS-TDD), LTE-TDD, WiMax, and/or time division synchronous code division multiple access (TD-SCDMA). In a time-division multiplexing (TDM) based backhaul link, synchronization may be achieved, for example if the transport technology used (e.g., T1 and/or E1, SONET and/or SDH) is inherently synchronous. In packet based transport networks that may use packetized Ethernet-based backhaul links, there may be no natural source for derivation of synchronization signals.

Precision time protocol (PTP), for example in accordance with IEEE 1588v2, may be implemented for synchronization in Ethernet-based backhaul networks. PTP may be used for both frequency and phase synchronization and may be implemented at the master and slave end-nodes, without requiring changes in one or more intermediate nodes. Global positioning system (GPS) and/or other global navigation satellite system (GNSS) based systems may be a source of synchronization. Reliance on GPS signals may present drawbacks, including: GPS signals may not be available at all deployment locations (e.g., street-side and/or dense-urban locations); and/or low power signals of a satellite based system may be susceptible to jamming.

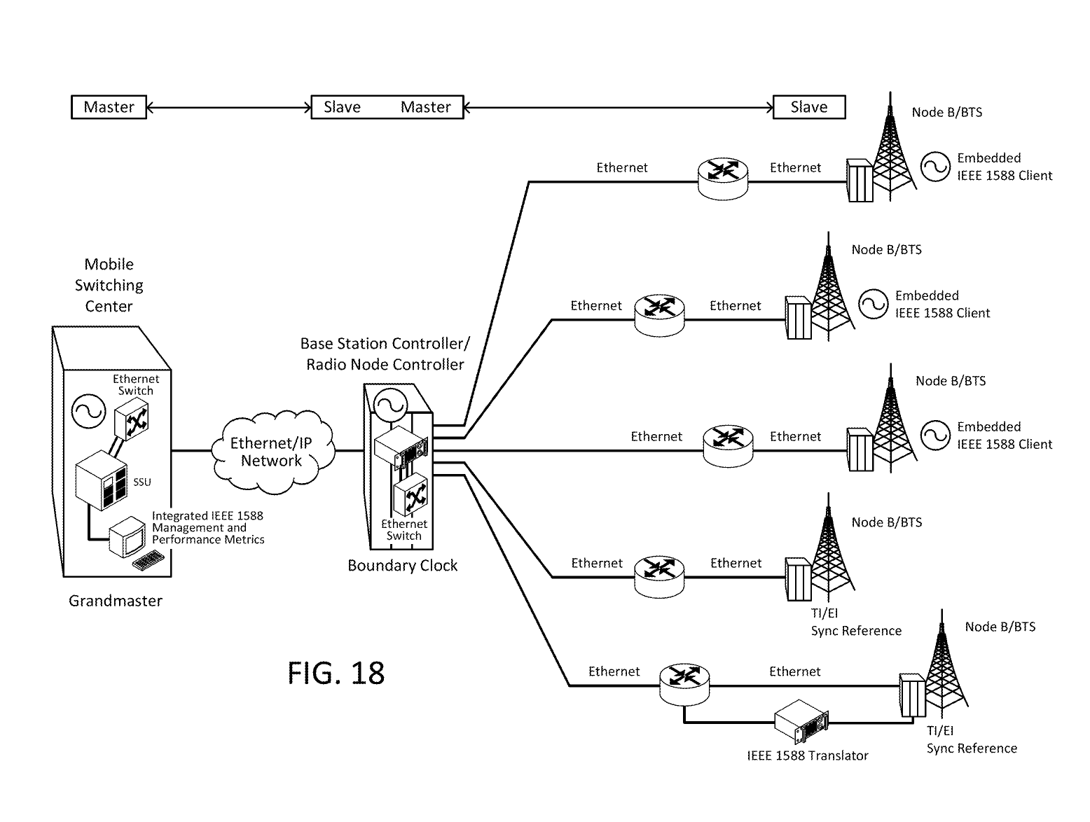

Through the passing of hardware time-stamped messages, PTP may enable the synchronization of end devices, which may be referred to as ‘slaves’ or ‘clients,’ to the clock of a ‘master’ device. In addition, a ‘boundary clock’ may be used, for example in the middle of a network, for example to relay synchronization messages and/or to reduce effects of propagation and/or other delays. An example deployment of PTP in a macro cellular network is illustrated in FIG. 18.

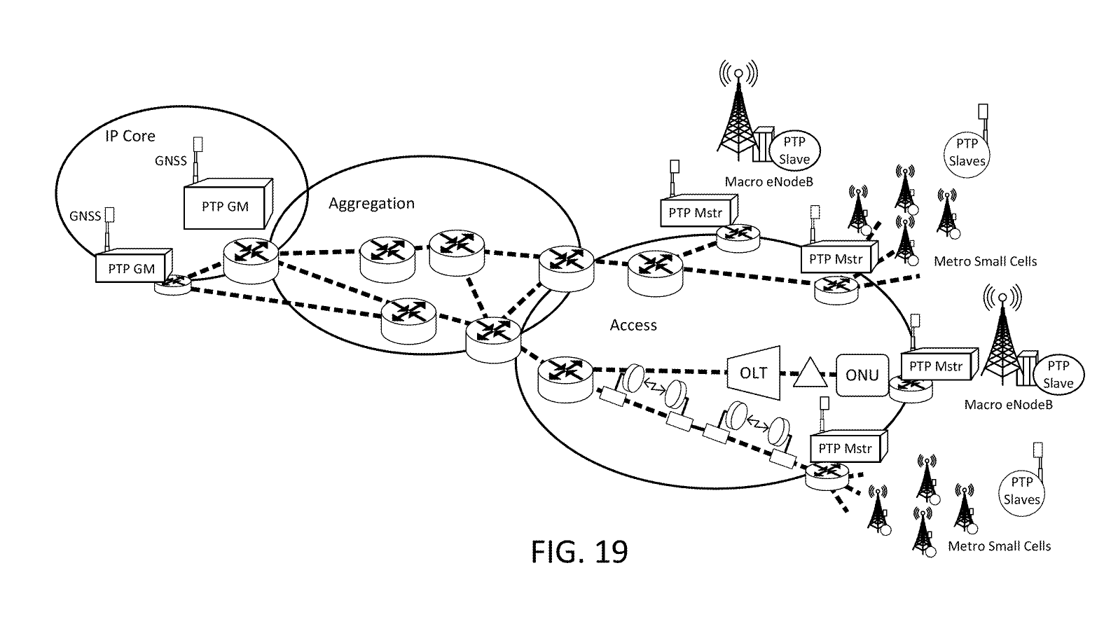

In a SCN, a PTP deployment may include a centralized grandmaster clock (e.g., located in a core of an associated macro cellular network), a boundary clock (e.g., located at a SC controller and/or gateway and/or cluster-head, and one or more PTP client devices (e.g., located at each SC AP. FIG. 19 depicts an example of a PTP deployment in a small cell network.

Synchronization between a master (or boundary) clock and a slave clock may include one or more of: measuring a propagation delay between the master and the slave (e.g., by using a delay request-response mechanism); or performing a clock offset correction (e.g., by advancing the slave time to be aligned to the master time). Delay estimation may be at least partially dependent on the former. For example, if the boundary clock is located at an edge of the wired and/or wireless backhaul boundary and/or if the Client is located substantially at the small cell AP, the delay measured by PTP may be based on a last-mile backhaul-induced delay.

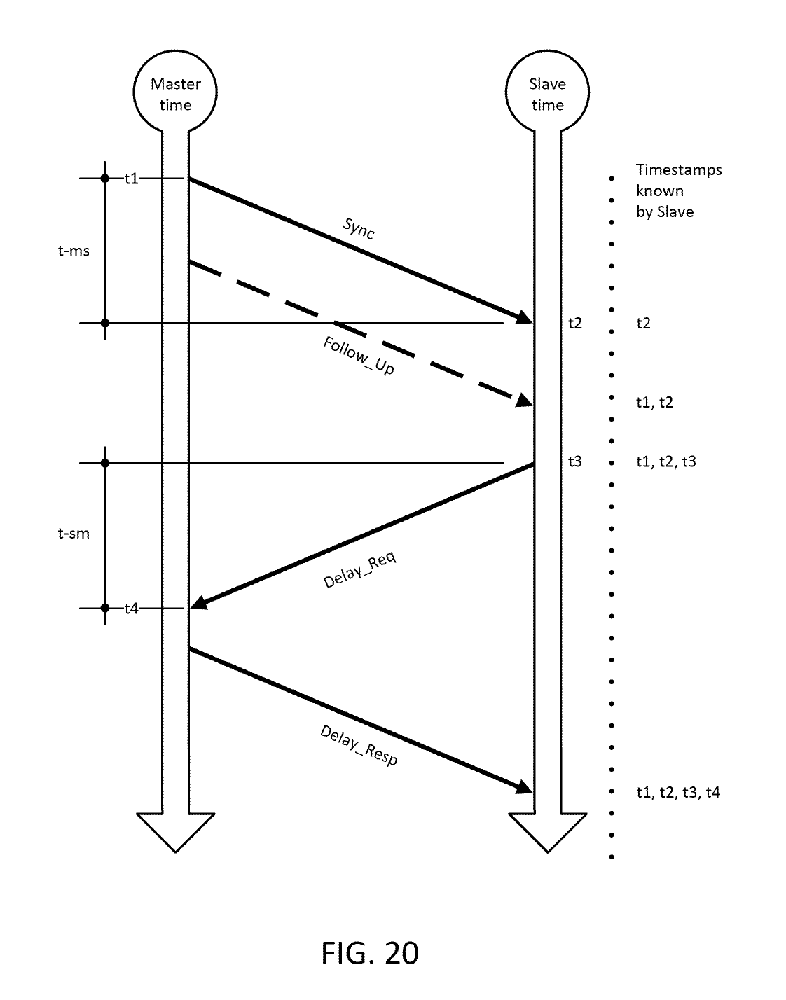

FIG. 20 illustrates an example baseline delay measurement technique. The illustrated baseline delay measurement technique may start with an arbitrary offset between the master and slave clocks and may determine a round-trip delay between the two nodes. If the mobile backhaul links are not symmetric, the technique may be enhanced, for example with a one-way delay measurement capability (e.g., to capture one-way delay from the master to the slave). In an example, t−ms=t2−t1−offset and t−sm=t4−t3+offset. If the link is assumed to be symmetric, t−ms=t−sm={(t2−t1)+(t4−t3)}/2.

A technique may be implemented to infer, at least approximately, a delay introduced by a backhaul. The inferred delay information may be made available at a small cell AP, for instance to help the SC AP make one or more substantially accurate delay-aware scheduling decisions. One or both of an absolute value of the delay and/or variations in the delay may be useful. An absolute value of the delay may be used for serving time-sensitive traffic, such as voice over Internet protocol (VoIP). Variable delay may be used to correctly assign relative priorities to one or more packets while scheduling. If a dominant cause of variations in the delay is due to a QCI-based differential treatment of packets at different points in the backhaul, a granularity of delay estimation may be at a per-QCI level.

Techniques may be implemented for estimating backhaul delay at a per-QCI level. For example, techniques implemented for estimating backhaul delay at a per-QCI level may involve one or more of the following: using PTP entities and/or messages; direct measurement of delays, for instance without relying on PTP; estimating delays accrued at multiple points starting from a core network up to an access point; using a hybrid GPS and PTP based approach for time synchronization; or incorporating backhaul delay in medium access control (MAC) scheduling decisions (e.g., decisions made at an AP).

PTP-based synchronization of an access point may involve the computation of backhaul delay, for instance intermediately. When a PTP infrastructure is deployed such that one or more synchronization messages take a path that is the same as a path taken by data packets, a delay computed by a PTP slave device may be used for the purpose of delay estimation.

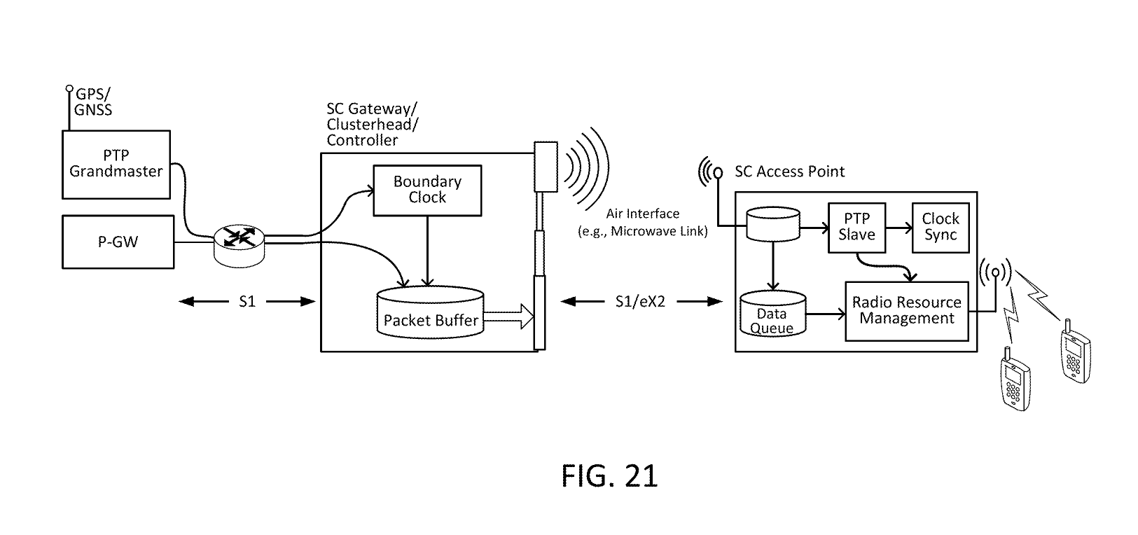

FIG. 21 depicts an example architecture using an established PTP infrastructure and associated messages. The illustrated PTP slave device may be implemented with an additional output interface that may be separate from an output interface that may function to provide a synchronized clock output. This additional output interface may include a delay estimated by the PTP slave (e.g., as an intermediate step for synchronization) that may be conveyed to associated radio resource management (RRM) functions. The RRM may be provided with a periodic estimate of one or more delays ensued by respective packets traversing the backhaul link. A periodicity of the delay estimates may be equal to that of one or more Synchronization messages used by the PTP protocol.

When provided with this information, the RRM may not assume a fixed delay of approximately 20 ms between the core network and the respective base station, and may choose a more accurate value, for example a value based on an estimate of the delay as measured by the PTP protocol. One or more packets arriving within a certain time period (e.g., all packets) may be assumed to have the same delay, even though one or more of the packets may have been subjected to differential treatment, for example based on respective QCI markings of the packets. Respective delays encountered by the synchronization messages may be different than that for other packets, for example due to respective higher-priority QCI markings. The PTP architecture illustrated in FIG. 21 may be implemented with minimal changes to established network elements, interfaces, and/or messages. Determining whether the illustrated architecture is implemented on a cellular network may be ascertained, for instance by checking if a PTP slave output is limited to a synchronized clock output or if an additional output is present, for instance an output going directed to an RRM function.

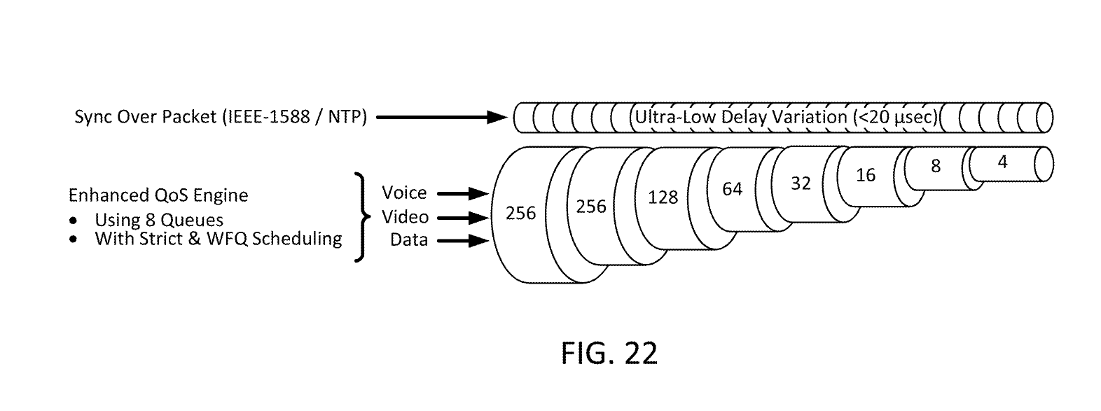

Delay values computed by a PTP slave, for example for RRM and/or other functions, may be re-used. PTP messages may be subjected to differential treatment in a backhaul system. PTP messages may be sensitive to large delays, and accordingly may be marked with a highest QoS marking and/or may not be subjected to queuing delays. For example, FIG. 22 illustrates segregation of PTP traffic into a dedicated fixed bandwidth channel that may not be subjected to adaptive coding and modulation and/or queuing delays. If PTP messages are sent through such dedicated bearers, a delay computed may reflect a transmission delay plus a lower bound of an actual queuing delay.

One or more techniques may be implemented in order to compute respective per-QCI delays more accurately. An example of such a technique may be to introduce of one or more additional messages pertaining to per-QCI delay estimation, without significantly impacting the operation of a grandmaster, boundary clocks and/or respective PTP slave devices.

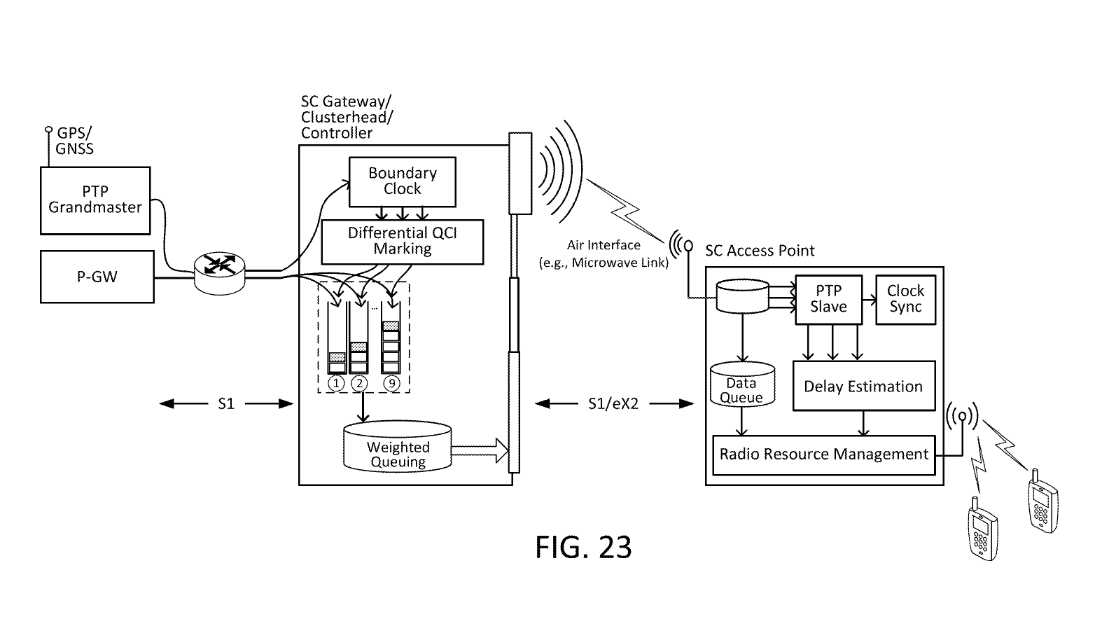

FIG. 23 depicts an example PTP Message Replication architecture in which multiple PTP sessions may be initiated from a PTP slave device to an associated boundary clock. Messages of one or more sessions (e.g., each session) may be marked with respective different QCI values. Messages from a session marked with a select QCI may be subjected to queuing delays for a corresponding class of traffic. Delays estimated by the PTP slave for each session may correspond to respective delays of data packets marked with different QCI markings. Depending on the desired accuracy of delay estimation, one or more messages may be replicated once for each offered QCI and/or a subset of offered QCI options. For example, two sessions may be used; one session for guaranteed bit rate traffic and another session for best effort traffic. Respective delay estimates may correspondingly have two levels of granularity. Messages from different sessions may be staggered, for instance in order to reduce traffic overhead.

Messages marked with a QCI corresponding to respective highest QoS rankings may be used for synchronization purposes. A PTP slave device may be enhanced in order to make synchronization related measurements through a single session and to pass on delay estimates from other sessions (e.g., directly) to an associated RRM and/or to other functions. This may introduce extra messaging overhead on a data path between a gateway and an access point and/or may capture per-QCI queuing delays incurred by packets of one or more different types. Multiple PTP sessions may be instantiated. If a number of replications are not of the same order as the number of different traffic classes, additional interpolations may be made at an AP, for example using a delay estimation function.

The above-described implementation may lead to transmission of multiple PTP synchronization messages that may be marked with different QCI values. As such, the implementation may be detected at respective queues at a gateway, at an associated air interface, and/or at an interface between the PTP slave and the RRM.

While the above may enhance delay estimation by incorporating per-QCI queuing delays, it may entail additional traffic overhead. For example, one or more respective Sync, Delay_Req, and/or Delay_Resp messages (e.g., all Sync, Delay_Req, and Delay_Resp messages) may be exchanged between a gateway and an AP for one or more (e.g., each) of a plurality of sessions established between the PTP slave and the boundary clock.

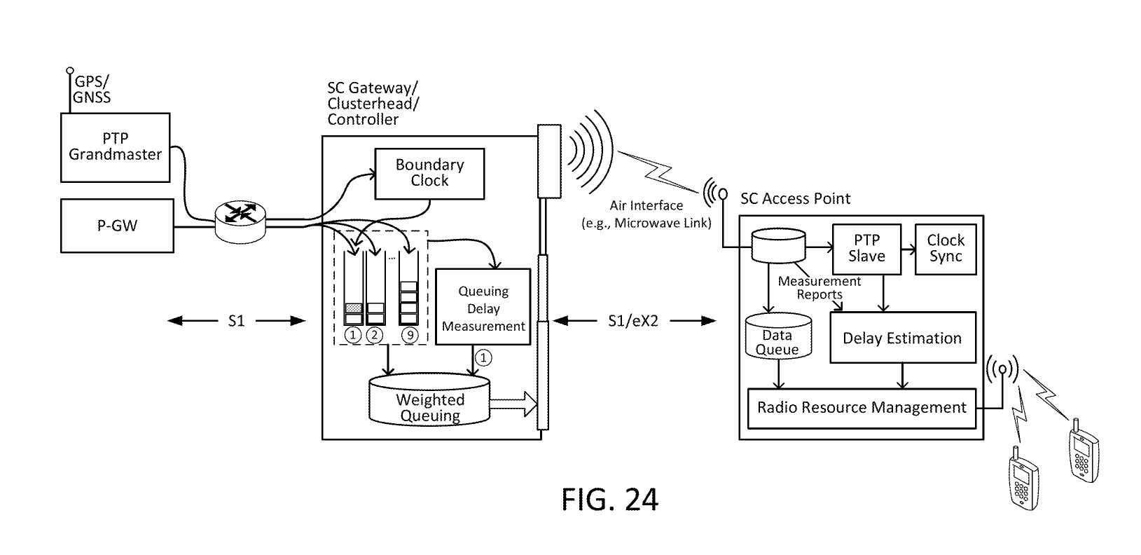

Such additional traffic overhead may be reduced by having a single PTP session (e.g., with messages marked with a highest QCI), and an average per-QCI queuing delay that may be measured and/or conveyed to an AP as a side-channel signal. For example, FIG. 24 depicts an example architecture that may implement side-channel signaling based delay estimation. In accordance with the FIG. 24, a propagation and/or transmission delay and/or a lower bound of a queuing delay may be captured by one or more PTP messages, and one or more side-channel measurement reports may be used to add per-QCI queuing delay, for example incurred at an associated gateway.

A queuing delay measurement function may be introduced in an associated gateway that may maintain a running average of respective queuing delays for one or more classes of traffic (e.g., for each class of traffic). This per-QCI measurement may be transmitted to an associated AP, for example periodically through an X2 and/or a S1 interface. On the AP side, the delay estimation function may take the lower bound of the delay from the PTP slave device and may add the reported measurements in order to determine an estimate of a total per-QCI delay. The total per-QCI delay estimate may be used for resource scheduling and/or other purposes. A rate of transmission of the measurement report may be determined, for instance in accordance with a desired level of accuracy in the delay estimation and/or a degree of variance in the delays. For example, if a respective queuing delay for a select class of traffic varies slowly with time, the frequency of reporting of the delays may be reduced. The above-described scheme may enable per-QCI delay estimation and may reduce traffic overhead, but additional measurement and/or reporting functionalities may be implemented at an associated gateway. If the above-described implementation incorporates a measurement function at an associated gateway and/or additional reporting through an X2 and/or S1 interface, detection may be made at the gateway, over the air, and/or at the associated AP.

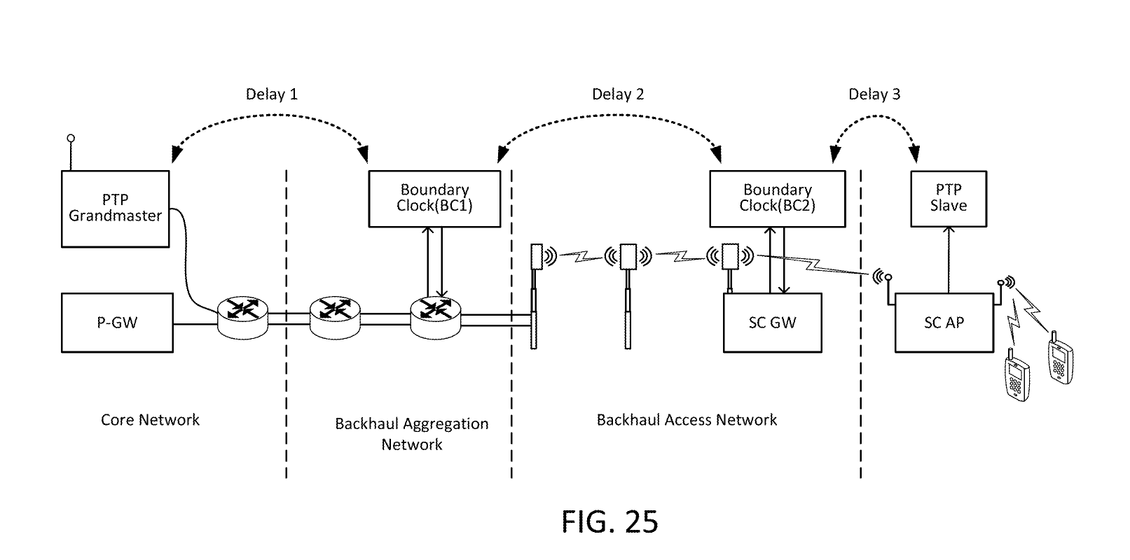

The above-described delay estimation may be extended in accordance with multiple hops in a cellular network, for example in accordance with a hierarchical topology involving different parts of an associated cellular network as illustrated in FIG. 25.

Depending, for instance, on a physical span of a cellular network, there may be zero, one, or more boundary clocks between a PTP clock source (e.g., a grandmaster) and a select PTP slave. A synchronization message exchange may take place between one or more PTP entities. For example, as depicted in FIG. 25, a synchronization message exchange may take place between a PTP grandmaster and a first boundary clock in the network (e.g., BC1), between the first BC and a second BC (e.g., BC2), and between BC2 and a PTP slave (e.g., a PTP slave in the SC AP). The above-described may apply, for instance, to delay estimation between BC2 and the PTP slave in the SC AP. If there are substantial delays in one or more of the other segments, substantially similar techniques may be applied to ascertain the delays in the one or more other segments, such as a delay between BC1 and BC2 and/or a delay between the grandmaster and BC1. Additional messages may be passed to transmit the delay measurements to the PTP slave. On the slave side, one or more delay reports pertaining to respective ones of the intermediate segment (e.g., all of the intermediate segment delay reports) may be added so as to determine a total delay along the path.

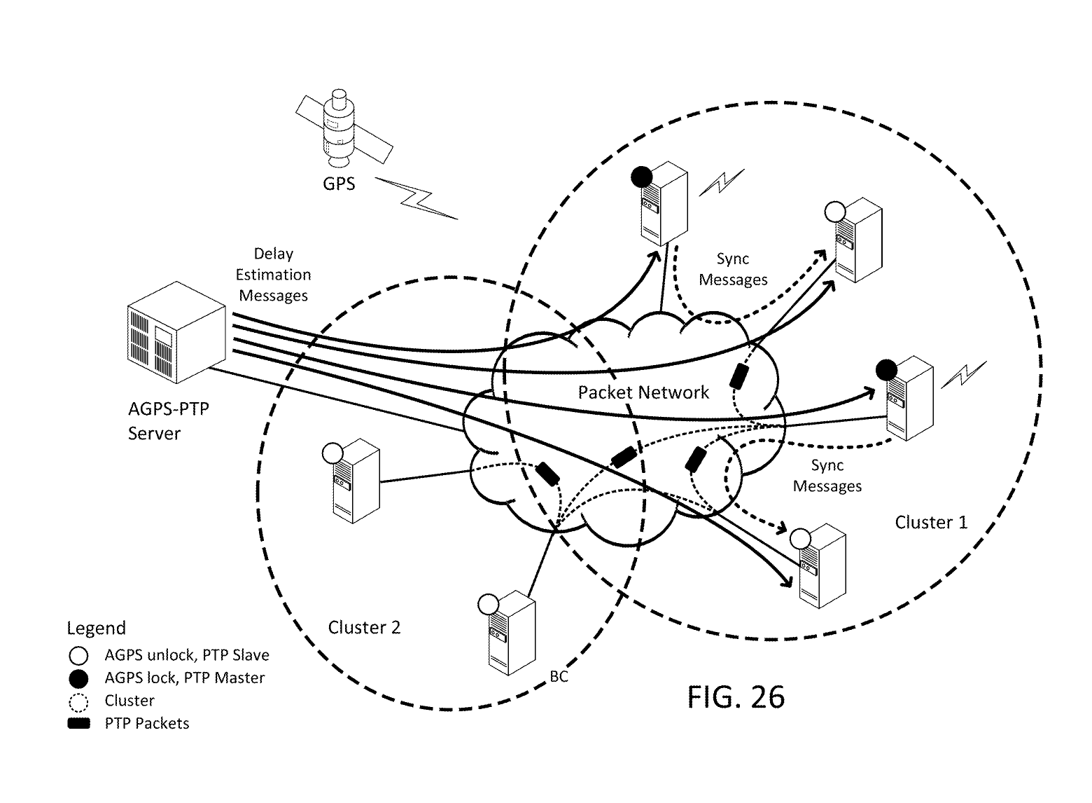

GPS signals may be at least partially relied on for synchronization. For instance, a hybrid synchronization scheme may be implemented using an architecture that may rely on GPS in cooperation with another synchronization mechanism (e.g., PTP). An SC AP may be equipped with a GPS receiver and a PTP slave device. If a GPS exhibits suitable signal reliability and/or availability, an associated AP may use the GPS for synchronization. When the GPS is at least partially compromised, for instance when its signal is weak and/or jammed, PTP synchronization messages may be used. If a cluster of APs configured for dual mode synchronization via GPS and PTP (e.g., dual mode SC APs) are deployed in a cluster, select APs in the cluster may receive a strong GPS signal while others receive a weak GPS signal. One or more APs with strong GPS signals may become respective PTP masters for one or more other APs in the cluster, for example as illustrated in FIG. 26.

Backhaul induced delays may be determined using variations of one or more of the features described herein. For example, synchronization messages may be separated (e.g., completely separated) from delay estimation messages. The synchronization messages may be sent by a nearby AP, for example with a GPS signal over an X2 interface, and the delay estimation messages may be exchanged between a PTP server and each AP. An associated PTP server may be modified, for instance to recognize and support a separate class of delay estimation messages in addition to PTP synchronization messages.

A precision timestamping capability provided by PTP may be used in estimating packet delay caused by one or more backhaul links. Aspects of the features described herein may be used to ascertain approximate packet delays in cases where PTP is not used for frequency and/or phase synchronization.

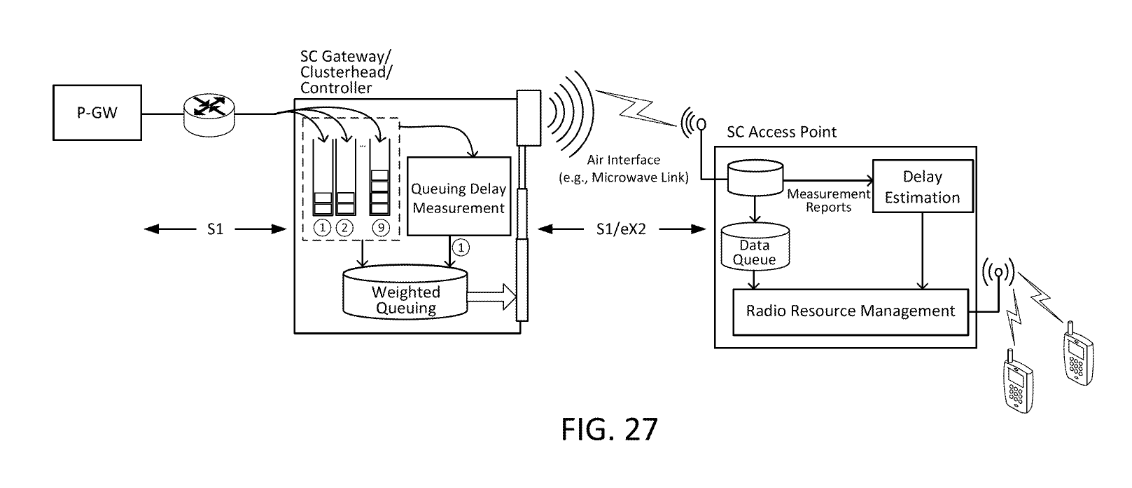

FIG. 27 depicts an example of side-channel signaling without the use of PTP messages. A source of variations in backhaul delay may be queuing at different points in a path from an associated core network to a SC AP. The above-described side-channel signaling technique, which may capture queuing delay, may be used without PTP synchronization messages. Due to the absence of PTP messages, propagation delay may not be captured, but a queuing part of the delay may be captured. An SC gateway, and/or any other node where significant queuing may occur, may maintain a running average of per-QCI queuing delays that may be measured locally. Periodically and/or upon triggering of pre-set conditions (e.g., more than a threshold change in delay values), respective measured per-QCI delays may be conveyed to SC APs, for example over an S1 interface and/or an enhanced X2 interface. If per-packet granularity of delay estimation is indicated as required, an addition that may include an amount of time the packet spent in the queue may be added to the header of each packet, for example. Additional processing time that may increase a total delay suffered by the packets may be implemented in accordance with such header additions.

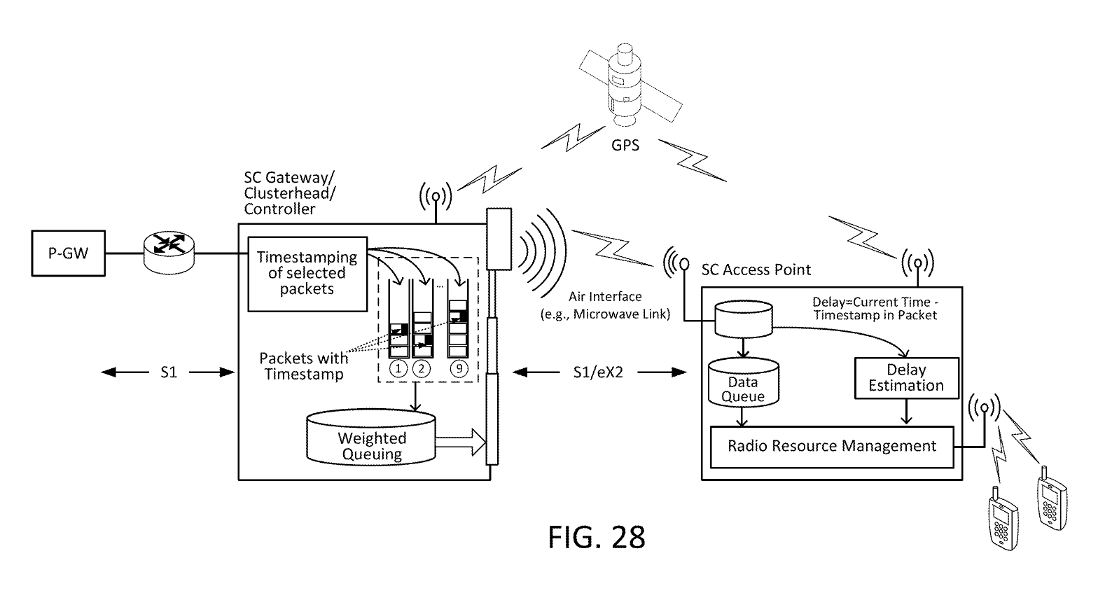

A timestamping technique may be implemented to determine queuing delays and/or propagation delays. FIG. 28 depicts an example architecture configured for timestamping-based delay estimation. Timestamping-based delay estimation may be implemented when delay is to be estimated between two entities that have a source from which to derive synchronized timestamps (e.g., a GPS). Packets flowing through an associated gateway may be stamped with a time that they are entered in a queue. Timestamping may be performed in a few packets (e.g., periodically). Packets belonging to different QCIs may be timestamped at different rates. With respect to an AP, if a received packet is found to include a timestamp, it may be processed, for instance to determine a time taken by the packet to traverse one or more queues and to propagate one or more air and/or wired mediums. If the AP is synchronized relative to an associated gateway, a delay suffered by the packet may be a difference of a time of arrival of the packet at the AP and a timestamp associated with the packet. Timestamping may not be accurate without the use of dedicated hardware support, and may introduce processing delay that other packets may not be subjected to. Delay determined with respect to the AP may include one or more built-in errors.

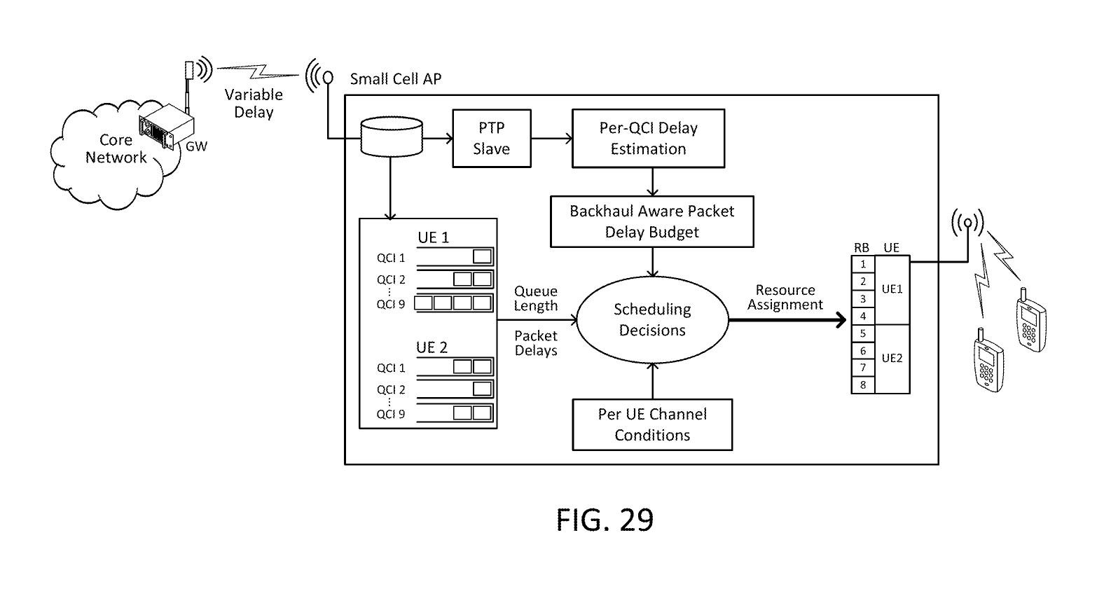

Backhaul delay aware scheduling may be implemented, for instance in accordance with MAC scheduling. FIG. 29 depicts an example architecture configured for use of PTP-based backhaul delay estimation for MAC scheduling. When allocating and/or sharing resources among one or more associated UEs, a scheduler may take account of respective traffic volumes and/or QoS indications pertaining to the one or more UEs and/or of radio bearers associated with the one or more UEs. An allocation of resource blocks (RBs) to the one more UEs may be determined in order to satisfy one or more pre-defined performance targets, for example in a process of downlink scheduling.

In each subframe, the scheduler, which may be located in a base station and/or AP, may grant spectral resources to one or more UEs for fresh transmissions and/or retransmissions, for example by taking one or more of the following inputs into account: channel conditions from the AP to the one or more UEs; a delay target of a packet awaiting transmission (e.g., based on a QCI marking); a delay accrued by the packet (e.g., while awaiting transmission at the AP); or a queue length of a per-UE queue of packets.

An earliest deadline first (EDF) and/or an earliest due date (EDD) scheduling policy may be modified to account for backhaul delay. The EDF scheduling policy may be optimal in terms of minimizing a number of packets that exceed a delay deadline. An EDF policy may be implemented to assign RBs one by one, such that each assignment is provided to a user whose head-of-line packet is nearest to a deadline.

For a base station and/or AP with N connected users indexed by i (1≦i≦N), wᵢ(t) may be a head-of-line delay of the i^{th} user at time t, such that wᵢ(t) may be an amount of time that an oldest packet of user i has been in a queue, waiting for transmission at the AP. A value dᵢ may be a delay target of a flow of the i^{th} user. For example, if the flow is conversational voice (e.g., QCI 1), d_{QCI(i)}=100 ms. Given these notations, an EDF scheduling policy may be described as:

```
For every subframe t:
  For every RB r ∈ (1,R)
    allocate RB r to a user i* (t), such that i* (t) = argmin_{1≦i≦N}(d_{QCI(i)} −
    wᵢ(t))
    update wᵢ(t)
  end
end
```

In backhaul situations, such as those described herein, because wᵢ(t) may capture delay accrued by a packet while waiting at an AP but may not capture delay in the backhaul, the term (d_{QCI(i)}−wᵢ(t)) may not capture a true time remaining till deadline, as intended. If an estimate of per-QCI delay (e.g., denoted by e_{QCI}) is available at the AP, for example through one or more of the techniques described herein, the above algorithm may be modified as follows, for instance to include both a backhaul delay as well as a scheduling delay:

```
For every subframe t:
  For every RB r ∈ (1,R)
    allocate RB r to a user i* (t), such that i* (t) = argmini_{1≦i≦N}(d_{QCI(i)} −
    e_{QCI(t) - w}ᵢ(t))
    update wᵢ(t)
  end
end
```

It should be appreciated that EDF is merely an example of how per-QCI backhaul delay estimates may be incorporated in MAC scheduling policies, and that one or more of the techniques described herein may be applied in other delay-aware scheduling policies and/or in policies that combine delay with channel quality and/or any other parameters.

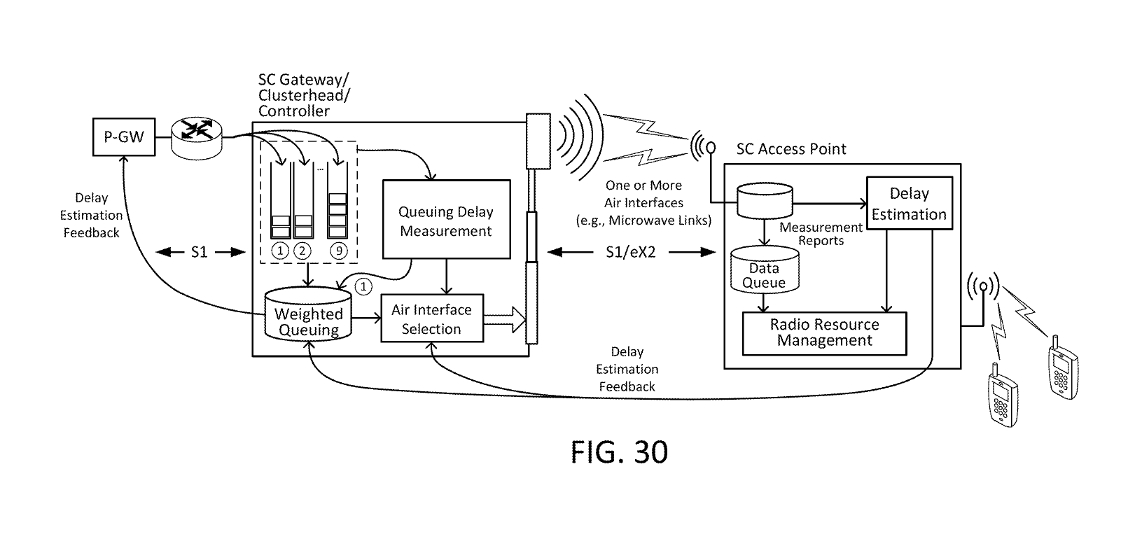

FIG. 30 depicts example functionalities that may be implemented in a wireless communication network that includes a small cell gateway (SC GW) that is configured to account for delay therethrough. For example, an SC GW may be configured to perform one or more of: establish multiple air interfaces between the SC GW and a small cell access point (SC AP); receive delay estimation feedback (e.g., delay estimation information) from the SC AP; use delay estimation feedback to select one or more air interfaces to use between the SC GW and the SC AP; or provide delay estimation feedback to a core network device (e.g., a PDN gateway). A PDN gateway (PGW) may be configured to use the delay estimation feedback to affect bearer establishment and/or modification. The PGW may be configured to use the delay estimation feedback to affect data queued at the SC GW by the PDN gateway.

One or more air interfaces may be established between the SC GW and the SC AP. As shown in FIG. 30, a plurality of air interfaces may be established between the SC GW and the SC AP. The term air interface is used because the interfaces are likely to be wireless connections, but are not so limited. For example, the plurality of air interfaces may be one or more WiFi links, WiMax links, microwave links, wired links, or a combination of wired and/or wireless links. It should be appreciated that while FIG. 30 depicts two air interfaces between the SC GW and the SC AP, there could be more than two air interfaces established between the SC GW and the SC AP (e.g., three, four, five, or more air interfaces). FIG. 30 illustrates a single SC AP connected to the SC GW, but the SC GW may support connections to more than one SC AP (e.g., a plurality of SC APs).

One or more SC APs associated with an SC GW may be configured to provide delay estimation feedback (e.g., delay estimation information) to the SC GW. The SC GW may be configured to receive delay estimation feedback from one or more SC APs associated with the SC GW. The delay estimation feedback may be received by a weighted queuing component of the SC GW and/or by an air interface selection (AIS) logic, for example.

The delay estimation information may be calculated by an SC AP, for example using one or more of the techniques described herein. The delay estimation information may be sent from the SC AP to the SC GW using an S1 interface, an eX2 interface, or another suitable interface. The delay estimation information may be added to one or more existing messages or may be placed in one or more unique messages that may be dedicated to delay estimation information.

An SC GW may be configured to use delay estimation feedback received at the SC GW (e.g., delay estimation feedback received from an SC AP). For example, an SC GW may use delay estimation feedback received from an SC AP in an AIS logic that may reside, for example, in the SC GW. An example AIS logic may proceed as follows.

An initial air interface between the SC GW and an SC AP may be selected by the AIS, for example upon activation of a wireless communication system that may include, for example, the SC GW, the SC AP, and/or a PGW. One or more data packets may be sent from the PGW to the SC GW. The one or more data packets may be sent from the SC GW to the SC AP over the selected air interface. The SC AP may calculate delay estimation information pertaining to the air interface, for example using one of the techniques described herein. The SC AP may use the delay estimation information, for example as described herein. The SC AP may send the delay estimation information to the SC GW.

The AIS logic may compare the received delay estimation information against a target delay estimation value. The comparison may be performed periodically, for example in accordance with a predetermined interval. The target delay estimation value used may vary, for example based upon the technique used to determine (e.g., compute) the delay estimation information. If a delay estimation is computed for all QoS Class Ids (QCIs), the delay estimation may be compared against a target delay estimation value that corresponds to a scalar limit. If the delay estimation is greater than the scalar limit, then the air interface between the SC GW and the SC AP may be changed. If respective delay estimations are computed for each QCI, the respective delay estimations may be compared against target delay estimation values that include corresponding predetermined limits (e.g., the limits found in 3GPP TS 23.203 v11.7.0, Table 6.1.7). If a threshold number of the respective delay estimations (e.g., a majority of the respective delay estimations) exceeds the corresponding predetermined limits, for example less some amount to account for data traversing one or more other nodes in the system, the air interface between the SC GW and the SC AP may be changed.

If the AIS determines that the air interface between the SC GW and the SC AP should be changed, for example by performing one of the above-described comparisons, the AIS may cause the SC GW to switch to a different air interface between the SC GW and the SC AP. For example, if there are two air interfaces between the SC GW and the SC AP (e.g., one currently used by the SC GW and one that is unused), the AIS logic may cause the SC GW to switch to the unused air interface. If there are more than two air interfaces between the SC GW and the SC AP (e.g., one currently used by the SC GW and two or more that are unused), the AIS logic may cause the SC GW to switch between the currently used air interface and one or more of the unused air interface (e.g., by periodically switching from channel to channel in accordance with a rotating pattern).

The periodicity of the AIS logic (e.g., the periodicity with which the AIS logic performs a comparison of received delay estimation information with the target delay estimation) may be based, for example, on the expiration of an interval of time or a number of packets processed by the SC GW. In an example, the periodicity may be a fixed value. The periodicity value may be configurable, for example when the system is activated.

The AIS logic may be configured to prevent thrashing between two or more air interfaces (e.g., channels). For example, the AIS logic may be configured such that if the respective delay estimations of two or more available channels exceed the corresponding predetermined limits, the AIS logic may select an air interface (e.g., a channel) with the lowest delay of the two or more available channels.

An SC GW may be configured to forward delay estimation information received from one or more SC APs. For example, an SC GW may be configured to provide delay estimation feedback (e.g., delay estimation feedback received from an SC AP) to a corresponding PGW. An SC GW may forward delay estimation information to a PGW using an S1 interface, for example. The delay estimation information may be added to one or more existing messages or may be placed in one or more unique messages that may be dedicated to delay estimation information. Source identification information may be included with the delay estimation information, for example when two or more SC APs are associated with the SC GW.

The PGW may be configured to setup and/or modify bearers based on delay estimation feedback (e.g., received from the SC GW). The PGW may receive delay estimation information corresponding to one or more SC APs (e.g., forwarded to the PGW by the SC GW). The delay estimation information for the one or more SC APs may be updated, for example periodically via delay estimation feedback received from the SC GW.

If the establishment of a bearer (e.g., responsive to a UE request to establish a bearer) will cause the delay estimation of a corresponding air interface to exceed a target delay estimation (e.g., corresponding predetermined limits) or the delay estimation of a corresponding air interface already exceeds a target delay estimation, the PGW may perform one or more actions.

The PGW may allow establishment of the bearer (e.g., despite the delay estimation exceeding QCI parameter limits). For example, emergency calls may be established despite a QCI budget being exceeded.

The PGW may disallow establishment of the bearer. For example, if establishment of the bearer will cause the system delay to exceed a target delay estimation for a corresponding QCI (e.g., a bearer request associated with guaranteed bitrate (GBR) for gaming), the request to establish the bearer may be denied.

The PGW may establish a bearer for the user using PGW-based IP flow mobility (IFOM). For example, if the bearer request is associated with buffered video streaming, the PGW may attempt to offload the UE requesting the bearer to an alternative channel resource (e.g., a WiFi channel).

The PGW may negotiate with the UE requesting the bearer. For example, the PGW may attempt to cause the UE to use a bearer with a QCI having a delay budget that is less strict than that of the requested bearer.

The PGW may perform one or more of the above-described techniques responsive to a request to modify an established bearer, for example if modification of the bearer will cause the delay estimation of a corresponding air interface to exceed a target delay estimation (e.g., corresponding predetermined limits).

The PGW may be configured to perform queuing changes based on delay estimation feedback (e.g., received from the SC GW). The PGW may push data packets to the SC GW for placement in respective QCI queues within the SC GW. If a corresponding SC AP reports delays (e.g., via delay estimation feedback) that exceed a target delay estimation (e.g., corresponding predetermined limits), the PGW may prioritize one or more packets of a specific QCI while delaying one or more packets of a different QCI. For example, one or more packets associated with GBR services may be sent to the SC GW while the sending of one or more packets associated with non-GBR services to the SC GW is delayed. This may allow the SC GW to push the GBR packets into a queue for transmission to the SC AP without congesting the SC GW with packets for non-GBR services.

An SC GW may be configured to perform the above-described queuing change techniques. For example, an SC GW may use delay estimation information received from an SC AP to promote one or more packets of a specific QCI into a stream of packets being sent to the SC AP while delaying sending to the SC AP one or more packets of a different QCI.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer. Features and/or elements described herein in accordance with one or more example embodiments may be used in combination with features and/or elements described herein in accordance with one or more other example embodiments.

1. A method for estimating delay associated with an air interface between a small cell gateway (SCGW) and a small cell access point (SCAP) that is connected to the SCGW via the air interface, the method comprising:
receiving queuing delay measurements over the air interface, the queuing delay measurements representative of respective delay measurements made on a plurality of packets queued at the SCGW, each of the plurality of packets having a respective QCI level associated therewith;
generating, based upon the queuing delay measurements, delay estimation information associated with the air interface; and
providing the delay estimation information to a radio resource management (RRM) function.

2. The method of claim 1, further comprising:
receiving a synchronization message that pertains to synchronizing the SCAP with the SCGW; and
incorporating propagation delay information from the synchronization message into the delay estimation information.

3. The method of claim 2, wherein the synchronization message is a precision time protocol message.

4. The method of claim 1, further comprising making a scheduling decision in accordance with the delay estimation information.

5. The method of claim 4, wherein the scheduling decision is made at a media access control layer.

6. The method of claim 1, further comprising transmitting the delay estimation information in a message addressed to the SCGW.

7. The method of claim 6, further comprising receiving, responsive to transmitting the delay estimation information, an indication of the establishment of a connection with the SCGW via a second air interface.

8. The method of claim 7, further comprising transmitting second delay estimation information pertaining to the second air interface in a second message addressed to the SCGW.

9. The method of claim 1, further comprising transmitting the delay estimation information in a message addressed to a packet data network gateway (PGW).

10. The method of claim 9, further comprising receiving at least one of an indication of the establishment of a bearer connection with the PGW or an indication of the modification of a bearer connection with the PGW.

11. A small cell access point (SCAP) that is connected to a small cell gateway (SCGW) via an air interface, the SCAP comprising:
a processor that is configured to:
receive queuing delay measurements over the air interface, the queuing delay measurements representative of respective delay measurements made on a plurality of packets queued at the SCGW, each of the plurality of packets having a respective QCI level associated therewith;
generating, based upon the queuing delay measurements, delay estimation information associated with the air interface; and
providing the delay estimation information to a radio resource management (RRM) function.

12. The SCAP of claim 11, wherein the processor is further configured to:
receive a synchronization message that pertains to synchronizing the SCAP with the SCGW; and
incorporate propagation delay information from the synchronization message into the delay estimation information.

13. The SCAP of claim 12, wherein the synchronization message is a precision time protocol message.

14. The SCAP of claim 11, wherein the processor is further configured to make a scheduling decision in accordance with the delay estimation information.

15. The SCAP of claim 14, wherein the scheduling decision is made at a media access control layer.

16. The SCAP of claim 11, wherein the processor is further configured to transmit the delay estimation information in a message addressed to the SCGW.

17. The SCAP of claim 16, wherein the processor is further configured to receive, responsive to transmitting the delay estimation information, an indication of the establishment of a connection with the SCGW via a second air interface.

18. The SCAP of claim 17, wherein the processor is further configured to transmit second delay estimation information pertaining to the second air interface in a second message addressed to the SCGW.

19. The SCAP of claim 11, wherein the processor is further configured to transmit the delay estimation information in a message addressed to a packet data network gateway (PGW).

20. The SCAP of claim 19, wherein the processor is further configured to receive at least one of an indication of the establishment of a bearer connection with the PGW or an indication of the modification of a bearer connection with the PGW.

21. A method for performing self-optimization of a wireless backhaul link between a backhaul hub (BH) and a backhaul cell-site unit (BCU) that is connected to the BH over the wireless backhaul link, the method comprising:
receiving a request to provision a specified bit rate over the backhaul link;
determining whether the request can be fulfilled, based upon available radio resources; and
if the request can be fulfilled, reconfiguring the backhaul link in accordance with the specified bit rate.

22. The method of claim 21, wherein the request is received from a policy and charging rules function (PCRF).

23. The method of claim 22, further comprising, if the request cannot be fulfilled, determining a revised bit rate.

24. The method of claim 23, further comprising reconfiguring the backhaul link in accordance with the revised bit rate.

25. The method of claim 23, further comprising negotiating the revised bit rate in accordance with a quality of service (QoS) parameter.

26. The method of claim 25, wherein the negotiating the revised bit rate includes sending at least one message that is addressed to the PCRF.
